(19) United States
(12) Patent Application Publication
(10) Pub. No.: US 2024/0303859 A1
(43) Pub. Date: Sep. 12, 2024

(54) 3D POSITION ACQUISITION METHOD AND DEVICE

(71) Applicant: The University of Tokyo, Bunkyo-ku, Tokyo (JP)

(72) Inventors: Yoshihiko NAKAMURA, Bunkyo-ku, Tokyo (JP); Yosuke IKEGAMI, Bunkyo-ku, Tokyo (JP); Takuya OHASHI, Chiyoda-ku, Tokyo (JP)

(21) Appl. No.: 18/549,351

(22) PCT Filed: Mar. 7, 2022
(86) PCT No.: PCT/JP2022/009773

§ 371 Date: Sep. 7, 2023

(30) Foreign Application Priority Data
Mar. 8, 2021 (JP) 2021-036594

(51) Int. Cl. G06T 7/73; G06T 17/00

(52) U.S. Cl. CPC G06T 7/74; G06T 17/00; G06T 2207/20081; G06T 2207/20084; G06T 2207/30196; G06T 2210/12

(57) ABSTRACT

he The target includes a plurality of keypoints of a body including a plurality of joints and the 3D position of the target is identified by positions of the plurality of keypoints. A bounding box and reference 2D joint position determining unit determines a bounding box surrounding the target in a camera image at a target frame to be predicted subsequent to at least one frame at which imaging is performed by the plurality of cameras using the 3D positions of the keypoints of the target at the at least one frame and acquires reference 2D positions of the keypoints projected from the 3D positions of the keypoints of the target onto a predetermined plane. A 3D pose acquiring unit acquires the 3D positions of the keypoints of the target at the target frame using image information in the bounding box and the reference 2D positions.

### TECHNICAL FIELD

The present disclosure relates to motion capture and more particularly to 3D position acquisition method and device.

### BACKGROUND ART

Motion capture is technology which is indispensable in acquisition and analysis of human motions and is widely used in the fields of sports, medicine, robotics, computer graphics, computer animation, and the like. Optical motion capture is known well as a system of motion capture. In optical motion capture, a motion of a target is acquired from movement traces of a plurality of optical markers coated with a retro-reflective material by attaching the optical markers to a body of the target and imaging the motion of the target using a plurality of cameras such as infrared cameras.

A system in which a so-called inertial sensor such as an acceleration sensor, a gyroscope, or a geomagnetic sensor is attached to a body of a target and motion data of the target is acquired is also known as another system of motion capture.

### CITATION LIST

### Patent Literature

[Non-Patent Literature 1] Z. Zhang, Microsoft kinect sensor and its effect, IEEE Multi Media, 19(2): 4-10, February 2012
[Non-Patent Literature 2] J. Shotton, A. Fitzgibbon, M. Cook, T. Sharp, M. Finocchio, R. Moore, A. Kipman, and A. Blake, Real-time human pose recognition in parts from single depth images. In Proceedings IEEE Conference on Computer Vision and Pattern Recognition. CVPR 2011, CVPR ′11, pages 1297-1304, Washington, DC, USA, 2011. IEEE Computer Society
[Non-Patent Literature 3] J. Tong, J. Zhou, L. Liu, Z. Pan, and H. Yan, Scanning 3d full human bodies using kinects. IEEE Transactions on Visualization and Computer Graphics, 18(4): 643-650, April 2012
[Non-Patent Literature 4] Luciano Spinello, Kai O. Arras, Rudolph Triebel, and Roland Siegwart, A layered approach to people detection in 3d range data, In Proceedings of the Twenty-Fourth AAAI Conference on Artificial Intelligence, AAAI′10, pages 1625-1630. AAAI Press, 2010
[Non-Patent Literature 5] A. Dewan, T. Caselitz, G. D. Tipaldi, and W. Burgard, Motion-based detection and tracking in 3d lidar scans, In 2016 IEEE International Conference on Robotics and Automation (ICRA), pages 4508-4513 May 2016
[Non-Patent Literature 6] C. J. Taylor, Reconstruction of articulated objects from point correspondences in a single uncalibrated image, In Proceedings IEEE Conference on Computer Vision and Pattern Recognition, CVPR 2000, volume 1, pages 677-684 vol. 1, 2000
[Non-Patent Literature 7] I. Akhter and M. J. Black, Pose-conditioned joint angle limits for 3d human pose reconstruction, In Proceedings IEEE Conference on Computer Vision and Pattern Recognition, CVPR 2015, pages 1446-1455 Jun. 2015
[Non-Patent Literature 8] Dushyant Mehta, Helge Rhodin, Dan Casas, Oleksandr Sotnychenko, Weipeng Xu, and Christian Theobalt, Monocular 3d human pose estimation using transfer learning and improved CNN supervision, The Computing Research Repository, abs/1611.09813, 2016
[Non-Patent Literature 9] Dushyant Mehta, Srinath Sridhar, Oleksandr Sotnychenko, Helge Rhodin, Mohammad Shaei, Hans-Peter Seidel, Weipeng Xu, Dan Casas, and Christian Theobalt, Vnect: Real-time 3d human pose estimation with a single RGB camera
[Non-Patent Literature 10] Angjoo Kanazawa, Michael J. Black, David W. Jacobs, and Jitendra Malik, End-to-end recovery of human shape and pose, arXiv: 1712.06584, 2017
[Non-Patent Literature 11] Xiao Sun, Jiaxiang Shang, Shuang Liang, and Yichen Wei, Compositional human pose regression, The Computing Research Repository, abs/1704.00159, 2017
[Non-Patent Literature 12] Openpose, https://github.com/CMU-Perceptual-Computing-Lab/openpose
[Non-Patent Literature 13] Shih-En Wei, Varun Ramakrishna, Takeo Kanade, and Yaser Sheikh, Convolutional pose machines, In Proceedings IEEE Conference on Computer Vision and Pattern Recognition, CVPR 2016, 2016
[Non-Patent Literature 14] Zhe Cao, Tomas Simon, Shih-En Wei, and Yaser Sheikh, Realtime multi-person 2d pose estimation using part affinity fields, In Proceedings IEEE Conference on Computer Vision and Pattern Recognition, CVPR 2017, 2017
[Non-Patent Literature 15] http://cocodataset.org/ #keypoints-leaderboard
[Non-Patent Literature 16] T. Ohashi, Y. Ikegami, K. Yamamoto, W. Takano, and Y. Nakamura, Video Motion Capture from the Part Confidence Maps of Multi-Camera Images by Spatiotemporal Filtering Using the Human Skeletal Model, 2018 IEEE/RSJ International Conference on Intelligent Robots and Systems (IROS), Madrid, 2018, pp. 4226-4231
[Non-Patent Literature 17] K. Ayusawa and Y. Nakamura, Fast inverse kinematics algorithm for large dof system with decomposed gradient computation based on recursive formulation of equilibrium, In 2012 IEEE/RSJ International Conference on Intelligent Robots and Systems, pages 3447-3452 Oct. 2012
[Non-Patent Literature 18] Y. Chen, Z. Wang, Y. Peng, Z. Zhang, G. Yu, and J. Sun, Cascaded Pyramid Network for Multi-Person Pose Estimation, In IEEE/CVF Conference on Computer Vision and Pattern Recognition (CVPR), 2018
[Non-Patent Literature 19] K. Sun, B. Xiao, D. Liu, and J. Wang, Deep High-Resolution Representation Learning for Human Pose Estimation, In IEEE/CVF Conference on Computer Vision and Pattern Recognition (CVPR), 2019
[Non-Patent Literature 20] B. Xiao, H. Wu, and Y. Wei, Simple Baselines for Human Pose Estimation and Tracking, In European Conference on Computer Vision (ECCV), 2018
[Non-Patent Literature 21] T. Ohashi, Y. Ikegami, and Y. Nakamura, Synergetic Reconstruction from 2D Pose and 3D Motion for Wide-Space Multi-Person Video Motion Capture in the Wild, Image and Vision Computing, Vol. 104, pp. 104028, 2020

### SUMMARY OF DISCLOSURE

### Technical Problem

With the optical system or the system using an inertial sensor, motion data with high precision can be acquired, but since a plurality of markers or a plurality of sensors need to be attached to a body of a target, there is a problem in that it may take time or labor to prepare motion measurement, motion of a target may be limited, and natural motion may be hindered. Since the system or devices are expensive, it is not technology which can be widely and generally used. In optical motion capture, there is a problem in that a measurement place is limited and thus it is difficult to acquire motion data of motions in an outdoor space or a wide space.

So-called markerless motion capture in which no optical marker or sensor is attached is also known. Examples of motion capture using cameras and depth sensors are described in Non-Patent Literatures 1 to 5. However, with such a system, temporal/spatial resolutions for acquiring depth data are low and thus it is difficult to measure a target which is in an outdoor space or a far place or which moves fast.

Since systems and precision of image recognition have been swiftly improved using deep learning, video motion capture of acquiring motion data by analyzing an RGB image from one viewpoint has been proposed (Non-Patent Literatures 6 to 11). Such a system can be used even under conditions of an outdoor space and a far place, and temporal-spatial resolutions can be enhanced at a relatively low cost by selecting performance of cameras. However, with measurement from one viewpoint, it is often difficult to estimate a pose of a target due to occlusion and thus precision thereof does not reach that of optical motion capture using a plurality of cameras.

Studies on finding a human shape from a single video image and generating a heat map indicating a likelihood spatial distribution of certainty of joint positions using deep learning have also been carried out. One representative study thereof is OpenPose (Non-Patent Literature 12). In OpenPose, estimation of keypoints such as wrists and shoulders of a plurality of persons from a single RGB image can be performed in real time. This has been developed based on a study on generating part confidence maps (PCM) of joints from a single RGB image using a CNN and estimating positions of the joints, which was performed by Wei et al., (Non-Patent Literature 13) and a study on calculating a vector length indicating a direction of neighboring joints and extending the aforementioned study to estimate joint positions of a plurality of persons in real time such as part affinity fields (PAFs), which was performed by Cao et al. (Non-Patent Literature 14). Various techniques have been proposed as techniques of acquiring a heat map (a PCM in OpenPose) which is a likelihood spatial distribution of certainty of joint positions, and a contest for competing for precision of a technique of estimating human joint positions from an input image has been held (Non-Patent Literature 15).

The inventors of the present disclosure have proposed video motion capture (Non-Patent Literature 16) of performing motion measurement with high precision similarly to optical motion capture as a technique of three-dimensionally reconstructing joint positions using heat map information. The video motion capture involves performing motion capture from images of a plurality of RGB cameras in a completely non-bounding manner and is a technique of enabling motion measurement in an indoor space, a wide outdoor space such as a sports field, and the like as long as a video can be acquired in principle.

A situation in which a plurality of persons play sports in the same space occurs often (sports competitions as a typical example), and it is important in motion capture to perform motion measurement of a plurality of persons. Two techniques are known as techniques of estimating poses of a plurality of persons based on an image including the persons. One technique is a bottom-up type of estimating joint positions of a plurality of persons in an image using heat map information or PCM and detecting poses of the persons using a vector length (for example, PAF) indicating directions of legs and arms or the like. The other technique is a top-down type of searching for areas of persons in an image, setting bounding boxes thereof, and detecting poses of the persons by estimating joint positions of the persons in the bounding boxes using heat map information. Some types of software for acquiring heat map information from image information in a bounding box are known (Non-Patent Literatures 18 to 20). When a plurality of persons are included in a bounding box, learning is performed such that heat map information or PCM of a most appropriate single person (for example, a person closer to the center of the image or a person of which all parts of a body are included in the bounding box) is acquired.

However, when detection of a person area in an input image is not appropriately performed, an appropriate bounding box may not be determined (for example, a wrist or an ankle is cut by an area surrounded by the bounding box) and erroneous estimation of joint positions of a person may be caused. As a resolution of an input image becomes higher, a calculation time for detecting a person area in an input image becomes longer. Accordingly, a bounding box needs to be appropriately determined with a smaller calculation load. This necessity is not limited to estimation of poses in an environment including a plurality of persons. When the number of targets in an image is one, it is possible to shorten the calculation time by calculating heat map information based on pixel information of a limited area surrounded by a bounding box.

An objective of the present disclosure is to acquire a pose with high precision even when a plurality of targets hug or the like and come into close contact in an image.

### Solution to Problem

According to an aspect of the present disclosure, there is provided a 3D position acquisition method that is performed by a device acquiring a 3D position of a target through motion capture using a plurality of cameras, wherein the target includes a plurality of keypoints of a body including a plurality of joints and the 3D position of the target is identified by positions of the plurality of keypoints, and wherein the 3D position acquisition method includes: determining a bounding box surrounding the target in a camera image at a target time to be predicted subsequent to at least one time at which imaging is performed by the plurality of cameras using the 3D positions of the keypoints of the target at the at least one time and acquiring reference 2D positions of the keypoints projected from the 3D positions of the keypoints of the target onto a predetermined plane; and acquiring the 3D positions of the keypoints of the target after the at least one time by performing three-dimensional reconstruction using image information in the bounding box, the reference 2D positions, and information of the plurality of cameras.

### Advantageous Effects of Disclosure

According to the present disclosure, it is possible to appropriately determine a bounding box by determining the bounding box based on 3D positions of keypoints of a prediction target. It is also possible to accurately predict the 3D positions of the keypoints of the target using the bounding box and 2D positions of the keypoints of the target at a present time or a past time.

### BRIEF DESCRIPTION OF DRAWINGS

FIG. 1 is a diagram illustrating an entire motion capture system.

FIG. 2 is a flowchart illustrating steps of processing an input image.

FIG. 3 is a flowchart illustrating processing steps for camera calibration and acquisition of an initial pose and an inter-joint distance of a skeletal model.

FIG. 4 includes a left part illustrating a skeletal model according to an embodiment and a right part illustrating keypoints of OpenPose.

FIG. 5 is a flowchart illustrating processing steps which are performed by a joint position candidate acquiring unit.

FIG. 6 is a diagram illustrating a point group which is a search range.

FIG. 7 is a flowchart illustrating processing steps which are performed by a joint position acquiring unit (when other lattice spacing is used).

FIG. 8 is a flowchart illustrating a step of rotating an input image and acquiring a PCM.

FIG. 9 is a flowchart illustrating video motion capture of a plurality of persons according to the embodiment.

FIG. 10 is a flowchart illustrating steps of processing an input image according to the embodiment.

FIG. 11 is a diagram illustrating determination of a bounding box according to the embodiment.

FIG. 12 is a flowchart illustrating processing steps which are performed by the joint position candidate acquiring unit according to the embodiment.

FIG. 13 is a diagram illustrating an example in which keypoints are detected when occlusion occurs.

FIG. 14 is a block diagram illustrating a functional configuration of a motion capture system 100 according to the present disclosure.

FIG. 15 is a diagram illustrating detailed processes which are performed by a bounding box and reference 2D joint position determining unit 102 according to an embodiment of the present disclosure.

FIG. 16 is a diagram illustrating a final heat map generating process based on a bounding box and a reference 2D pose.

FIG. 17 is a diagram illustrating an example of a hardware configuration of the motion capture system 100 according to the embodiment of the present disclosure.

### DESCRIPTION OF EMBODIMENTS

Two chapters which are the technical premise of embodiments of the present disclosure will be described below.

### [I] Motion Capture System

### [II] Motion Capture of Two or More Targets

In Chapter I, a video motion capture system will be described in detail. In Chapter II, an embodiment in which a technique according to Chapter I is applied to motion capture of a plurality of targets will be described. It should be understood by those skilled in the art that description of Chapter I and description of Chapter II are closely associated with each other and description of any one chapter can be appropriately used for another chapter. Expression numbers are independent between Chapter I and Chapter II.

### [I] Motion Capture System

### [A] Entire Configuration of Motion Capture System

The motion capture system is a so-called video motion capture system (see Non-Patent Literature 16) and serves to perform three-dimensional reconstruction of joint positions estimated using deep learning on the basis of images of a plurality of cameras of a target. The target does not have to wear any marker or sensor, and a measurement space is not particularly limited. The motion capture system is a technique of performing motion capture from images of a plurality of RGB cameras in a completely non-bounding manner and enabling motion measurement in an indoor space and an outdoor wide space such as a sports field as long as an image can be acquired in principle.

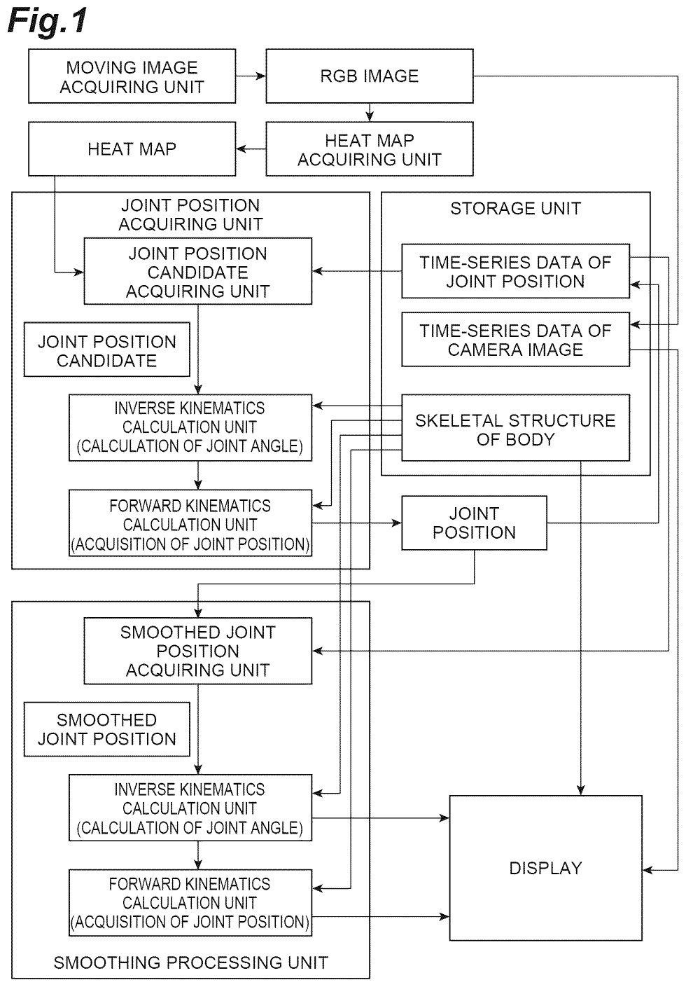

As illustrated in FIG. 1, the motion capture system according to an embodiment includes a moving image acquiring unit configured to acquire a motion of a target, a heat map acquiring unit configured to acquire heat map information for displaying degrees of certainty of positions of keypoints including joint positions in color intensities based on the image acquired by the moving image acquiring unit, a joint position acquiring unit configured to acquire joint positions of the target using the heat map information acquired by the heat map acquiring unit, a smoothing processing unit configured to smooth the joint positions acquired by the joint position acquiring unit, a storage unit configured to store a skeletal structure of a body of the target, time-series data of the image acquired by the moving image acquiring unit, and time-series data of the joint positions acquired by the joint position acquiring unit, and a display configured to display the image of the target acquired by the moving image acquiring unit and the skeletal structure corresponding to a pose of the target. Since the keypoints of the body of the target are mainly joints, the word “joints” is used to represent the keypoints in this specification and the drawings, but it should be noted that “joints” and keypoints do not completely correspond to each other as will be described later.

Hardware of the motion capture system according to an embodiment includes a plurality of cameras constituting the moving image acquiring unit, one or more local computers acquiring a camera image, and one or more computers and one or more displays connected thereto via a network. Each computer includes an input unit, a processing unit, a storage unit (a RAM or a ROM), and an output unit. In a certain embodiment, one local computer corresponds to one camera to acquire a camera image and to constitute the heat map acquiring unit, and the joint position acquiring unit, the smoothing processing unit, and the storage unit are constituted by one or more computers connected via a network. In another embodiment, a local computer connected to a camera compresses an image according to necessity and transmits the compressed image to the network, and the heat map acquiring unit, the joint position acquiring unit, the smoothing processing unit, and the storage unit are constituted by a computer connected thereto.

The cameras are synchronized with each other, camera images acquired at the same time are transmitted to the corresponding heat map acquiring unit, and a heat map is generated by the heat map acquiring unit.

A heat map indicates a spatial distribution of likelihoods of certainty of positions of keypoints on a body. The generated heat map information is transmitted to the joint position acquiring unit, and joint positions are acquired by the joint position acquiring unit. The acquired joint position data is stored as time-series data of the joint positions in the storage unit. The acquired joint position data is transmitted to the smoothing processing unit, and smoothed joint positions and joint angles are acquired. A pose of the target is determined from the smoothed joint positions and joint angles and a skeletal structure of the body of the target, and a motion of the target including the time-series data of the pose is displayed on the display.

The moving image acquiring unit includes the plurality of cameras which are synchronized, for example, using an external synchronization signal generator. The method of synchronizing a plurality of camera images is not particularly limited. The plurality of cameras are disposed to surround the target, and moving images of the target from multiple viewpoints are acquired by simultaneously imaging the target using all or some of the cameras. For example, an RGB image of 60 fps and 1024×768 is acquired from each camera, and the RGB images are transmitted to the heat map acquiring unit in real time or in non-real time.

In this embodiment, the moving image acquiring unit includes a plurality of cameras, and a plurality of camera images which are acquired at the same time are transmitted to the heat map acquiring unit. The heat map acquiring unit generates a heat map based on the images input from the moving image acquiring unit. In the motion capture system, the number of targets included in one image is not particularly limited. Motion capture of a plurality of targets will be described in the next chapter.

In acquisition of a motion using the motion capture system, a target includes a link structure or an articulated structure. Typically, the target is a person, and the articulated structure is a skeletal structure of a human body. When training data used by the heat map acquiring unit can be prepared for each target, the motion capture system can be applied to a target other than a human being (for example, an animal other than a human being or a robot).

Measurement data or processing data is stored in the storage unit. For example, time-series data of images acquired by the moving image acquiring unit and joint position data and joint angle data acquired by the joint position acquiring unit are stored. Smoothed joint position data and smoothed joint angle data acquired by the smoothing processing unit, heat map data generated by the heat map acquiring unit, and data generated in the course of other processing may be stored in the storage unit.

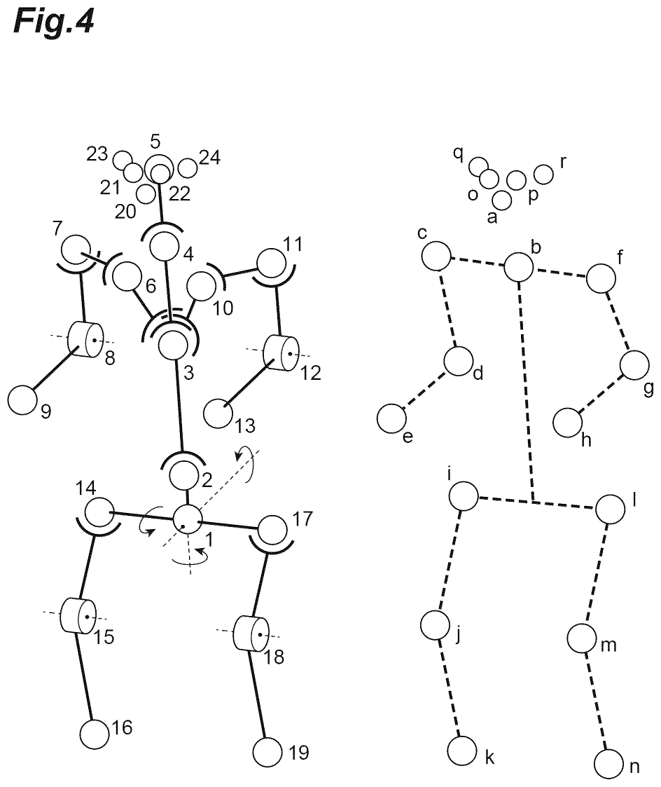

Data for determining a skeletal structure of a body of a target is stored in the storage unit. This data includes a file defining a skeletal model of a body and inter-joint distance data of a target. Joint angles or a pose of a target is determined from the joint positions of the skeletal model which is an articulated body. A skeletal model used in this embodiment is illustrated in the left part of FIG. 4. The skeletal model illustrated in the left part of FIG. 4 has 40 degrees of freedom, but this skeletal model is merely an example. As will be described later, constants indicating distances between neighboring joints of a target can be acquired at the time of initial setting for motion capture. The inter-joint distances of the target may be acquired in advance using another method, or inter-joint distances which have already been acquired may be used. In this embodiment, constraint conditions in which inter-joint distances are temporally invariable and which are specific to a skeletal structure can be provided in calculation of joint positions using the skeletal structure data of a body of a target.

A moving image of a target acquired by the moving image acquiring unit, a time-series skeleton image indicating a pose of the target acquired through motion capture, and the like are displayed on the display. For example, the processing unit of the computer generates skeleton image (target pose) data for each frame using a skeletal structure specific to a target and time-series data of the calculated joint angles and joint positions, outputs the generated skeleton image data at a predetermined frame rate, and displays the skeleton image data as a moving image on the display.

### [B] Heat Map Acquiring Unit

The heat map acquiring unit generates a two-dimensional or three-dimensional spatial distribution of likelihoods of certainty of positions of keypoints on a body including joint positions based on an input image and displays the spatial distribution of likelihoods in the form of a heat map. A heat map is obtained by displaying values spreading and varying in a space in color intensities in the space like a temperature distribution and enables visualization of likelihoods. A likelihood value ranges, for example, from 0 to 1, but scales of the likelihood values are arbitrary. In this embodiment, the heat map acquiring unit has only to acquire a spatial distribution of likelihoods of certainty of positions of keypoints on a body including joints, that is, heat map information (in which each pixel in an image has a value indicating a likelihood) and does not have to display a heat map.

Typically, the heat map acquiring unit estimates positions of keypoints on a body of a target (typically, joint positions) from an input single image as a heat map using a convolutional neural network (CNN). The convolutional neural network (CNN) includes an input layer, an intermediate layer (a hidden layer), and an output lay, and the intermediate layer is constructed through deep learning using training data of presence positions in two-dimensional mapping of keypoints onto an image.

In this embodiment, likelihoods acquired by the heat map acquiring unit are given to pixels in a two-dimensional image, and information of certainty of three-dimensional presence positions can be acquired by combining heat map information from a plurality of viewpoints.

OpenPose (Non-Patent Literature 12) which is open software can be exemplified as the heat map acquiring unit. In OpenPose, 18 keypoints on a body are set (see the right part of FIG. 4). Specifically, the 18 keypoints include 13 joints, a nose, right and left eyes, and right and left ears. OpenPose generates part confidence maps (PCM) of the 18 keypoints on the body from RGB images acquired by a plurality of cameras synchronized with each other offline or in real time by using a trained convolutional neural network (CNN) and displays the PCM in the form of a heat map. In this specification, although the word “PCM” is used for a spatial distribution of likelihoods of certainty of positions of keypoints on a body or a heat map, it should be noted that an index indicating the spatial distribution of likelihoods of certainty of positions of keypoints on a body including joint positions is limited to the PCM.

A technique other than OpenPose can be used for the heat map acquiring unit. Various techniques for acquiring a heat map indicating certainty of positions of keypoints on a body of a target have been proposed. For example, techniques ranked high in the COCO Keypoints Challenge (Non-Patent Literature 15) may be employed. A learning machine for the heat map acquiring unit may be independently prepared to construct a convolutional neural network (CNN).

### [C] Initial Setting of Motion Capture System According to Embodiment

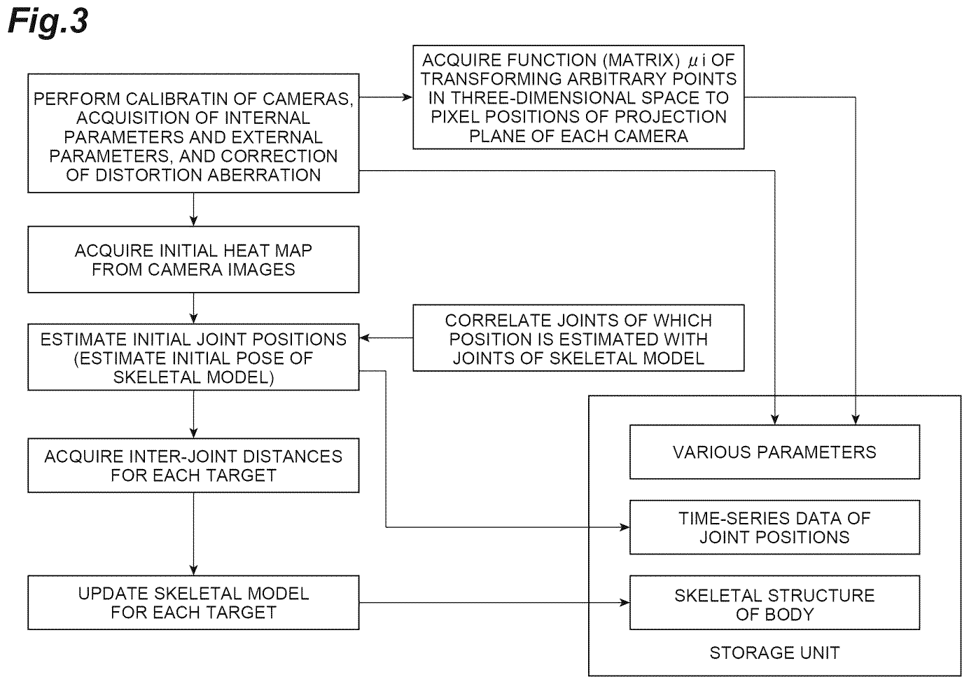

Calibration of cameras, acquisition of an initial pose of a skeletal model, and acquisition of inter-joint distances of a target in the motion capture system according to the embodiment will be described below with reference to FIG. 3.

### [C-1] Camera Calibration

In motion capture using a plurality of cameras, camera parameters for three-dimensionally reconstructing a plurality of camera images need to be acquired. A matrix Mᵢ for projecting an arbitrary point in a three-dimensional space onto an image plane of a camera i is expressed as follows.

$${M}_{i} ≡ {K}_{i} [ {R}_{i} \vert {t}_{i} ] \qquad [ Math . 1 ]$$

Here, Kᵢ is an internal parameter such as a focal distance or an optical center, Rᵢ and tᵢ are external parameters indicating a pose and a position of each camera. Camera calibration can be performed by imaging a calibration mechanism (such as a checker board or a calibration wand) with a known shape or dimension using a plurality of cameras. A distortion parameter can be acquired at the same time as the internal parameters. When an imaging space of a camera is a wide space, for example, a spherical member may be imaged using a plurality of cameras while moving all over a measurement area and central coordinates of the spherical member in each camera image may be detected without using the calibration mechanism. The external parameters are acquired by optimizing poses and positions of the cameras through bundle adjustment using the central coordinates of the spherical member in the camera images. The internal parameters can be acquired in advance using a calibration mechanism or the like, but some or all of the internal parameters may be acquired through optimized calculation at the same time as the external parameters.

When the projection matrix Mᵢ is acquired for each camera, a pixel position when a point X in a three-dimensional space is projected onto an image plane of each camera is expressed as follows.

$${μ}_{i} ( X ) = ( \begin{matrix}{[ {M}_{i} X ]}_{x} / {[ {M}_{i} X ]}_{z} \\ {[ {M}_{i} X ]}_{y} / {[ {M}_{i} X ]}_{z}\end{matrix} ) \qquad [ Math . 2 ]$$

A function (matrix) μᵢ for converting an arbitrary point in a three-dimensional space to a pixel position on the image plane of the camera i is stored in the storage unit.

[C-2] Joints of a skeletal model and a corresponding skeletal model (the left part of FIG. 4) of keypoints on a body of which a heat map is generated and the keypoints on the body (the right part of FIG. 4, where a, o, p, q, and r are excluded) acquired by the heat map acquiring unit are correlated. This correlation is shown in Table 1.

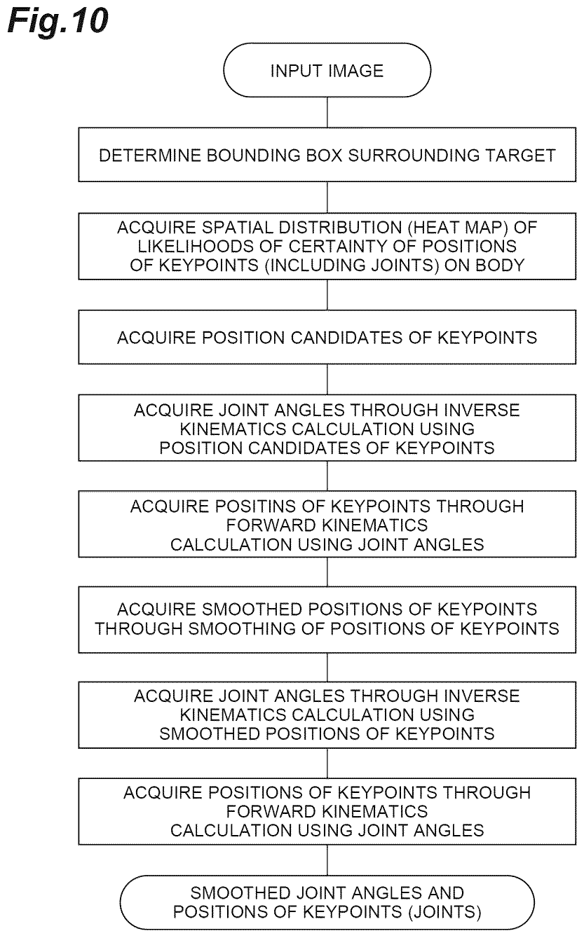

TABLE 1
Correspondence of Human Model to OpenPose

| 40DOF Human Model (FIG. 10 left) | | | OpenPose (FIG. 10 right) |
|---|---|---|---|
| Joint Number | Name | DOF | Reference |
| 1 | Pelvis (Base body) | 6 | — |
| 2 | Waist | 3 | — |
| 3 | Chest | 3 | — |
| 4 | Neck | 3 | b |
| 5 | Head | 3 | — |
| 6 | Right Clavicle | 3 | — |
| 7 | Right Shoulder | 3 | c |
| 8 | Right Elbow | 1 | d |
| 9 | Right Wrist | 0 | e |
| 10 | Left Clavicle | 3 | — |
| 11 | Left Shoulder | 3 | f |
| 12 | Left Elbow | 1 | g |
| 13 | Left Wrist | 0 | h |
| 14 | Right Hip | 3 | i |
| 15 | Right Knee | 1 | j |
| 16 | Right Ankle | 0 | k |
| 17 | Left Hip | 3 | l |
| 18 | Left Knee | 1 | m |
| 19 | Left Ankle | 0 | n |

The joints of the skeletal model according to this embodiment do not completely match the 18 keypoints in OpenPose. For example, keypoints corresponding to the pelvis (a base body), the waist, the chest, the right clavicle, the left clavicle, and the head of the skeletal model are not present in OpenPose. The joints in the skeletal model according to this embodiment and the 18 keypoints in OpenPose are representative keypoints of the keypoints on a body and do not include all possible keypoints. For example, more detailed keypoints may be set.

Alternatively, all the keypoints on a body may be joints. A joint angle which is not determined by only the 18 keypoints in OpenPose is determined as an optimization result in consideration of limits of movable ranges. When the joints of the skeletal model and the keypoints of which a spatial distribution of likelihoods is acquired correspond to each other initially, this correlation is not necessary.

### [C-3] Acquisition of Initial Pose and Inter-Joint Distances of Skeletal Model

An initial pose serving as a start point of motion measurement of a target is acquired. In this embodiment, estimation of inter-joint distances and the initial pose is performed based on pixel positions of keypoints calculated by applying OpenPose to images of which distortion aberration has been corrected. First, an initial heat map is acquired based on an initial image acquired by each camera. In this embodiment, rays connecting the optical centers of the cameras and pixel positions of the centers of gravity of the initial heat maps of the keypoints calculated using OpenPose are considered from the cameras, two cameras of which a common perpendicular line of the rays is minimized are determined, a midpoint between two legs of the common perpendicular line is calculated as a position of a three-dimensional keypoint when the length of the common perpendicular line is equal to or less than a predetermined threshold value (for example, 20 mm), and the inter-joint distances and the initial pose of the skeletal model are acquired using them.

Various techniques can be employed as a technique of estimating an initial position of a keypoint by those skilled in the art. For example, an initial position of a keypoint in a three-dimensional space can be estimated by a direct linear transformation (DLT) method using positions of corresponding points in the camera images and the camera parameters. Three-dimensional reconstruction using the DLT method is known to those skilled in the art and thus detailed description thereof will be omitted.

A constant of a distance between neighboring keypoints (inter-joint distance), that is, a link length, is required for optimized calculation based on inverse kinematics, but the link length varies for each target and thus a skeletal model link length is calculated for each target. In order to improve precision of motion capture according to this embodiment, it is preferable to perform scaling for each target. The skeletal model is a model with a standard skeletal structure of human beings, and a skeletal model suitable for a body type of a target is generated by scaling the skeletal model over the entire body or for each part.

In this embodiment, the link lengths of the skeletal model are updated based on the acquired initial pose. Regarding the initial link lengths of the skeletal model, scaling parameters used to update the link lengths are calculated from the positions of the keypoints based on the correspondence of FIG. 4 and Table 1. Out of the link lengths in the left part of FIG. 4, keypoints corresponding to the link lengths of 1-2, 2-3, 3-4, 3-6, 3-10, 6-7, and 10-11 are not present, and thus scaling parameters are not determined in the same way. Accordingly, lengths are determined using the scaling parameters of the other link lengths. In this embodiment, since a human skeleton has lengths which are basically symmetric on the right and left sides, the scaling parameters are calculated from an average of the right and left sides such that the scaling parameters are equal on the right and left sides, and the initial link lengths of the skeletal model are equal on the right and left sides. In calculation of the scaling parameter between the neck and the head, the scaling parameter is calculated with a midpoint between the keypoint positions of both ears as a position of the head joint. The link lengths of the skeletal model are updated using the acquired scaling parameters. In calculation of positions of the nose, the eyes, and the ears, the positions of the virtual joints (the nose, the eyes, and the ears) are calculated based on the correlation shown in Table 2.

TABLE 2
Correspondence of Human Model to OpenPose

| 40DOF Human Model (FIG. 10 left) | | | OpenPose (FIG. 10 right) |
|---|---|---|---|
| Joint Number | Name | DOF | Reference |
| 5 | Head | 3 | — |
| 20 | Nose | 0 | a |
| 21 | Right Eye | 0 | o |
| 22 | Left Eye | 0 | p |
| 23 | Right Ear | 0 | q |
| 24 | Left Ear | 0 | r |

The link lengths may be acquired using another technique, or link lengths which have been already acquired may be used. Alternatively, when a skeletal model specific to a target is acquired, the acquired skeletal model may be used.

### [D] Joint Position Acquiring Unit

The joint position acquiring unit is characterized in that the joint angles and the joint positions of the skeletal model are updated by estimating joint position candidates using heat map information (a spatial distribution of likelihood of certainty of positions of keypoints) acquired from the heat map acquiring unit and performing optimized calculation based on inverse kinematics using the joint position candidates. The joint position acquiring unit includes a joint position candidate acquiring unit configured to estimate joint position candidates based on the heat map data, an inverse kinematics calculation unit configured to calculate joint angles by performing the optimized calculation based on inverse kinematics using the joint position candidates, and a forward kinematics calculation unit configured to calculate joint positions by performing forward kinematics calculation using the calculated joint angles.

The joint position acquiring unit according to this embodiment acquires the joint position candidates at a frame t+1 using the spatial distribution of likelihoods acquired at the frame t+1 by setting a search range of each joint position candidate using the joint positions acquired at one or more frames. Examples of the search range include a nearby space of each joint position acquired at a frame t and a nearby space of a predicted position of each joint position predicted at the frame t+1. When a moving speed of a target is high, the latter is more advantageous. In this chapter, the former search range will be described, and the latter search range will be described in the next chapter.

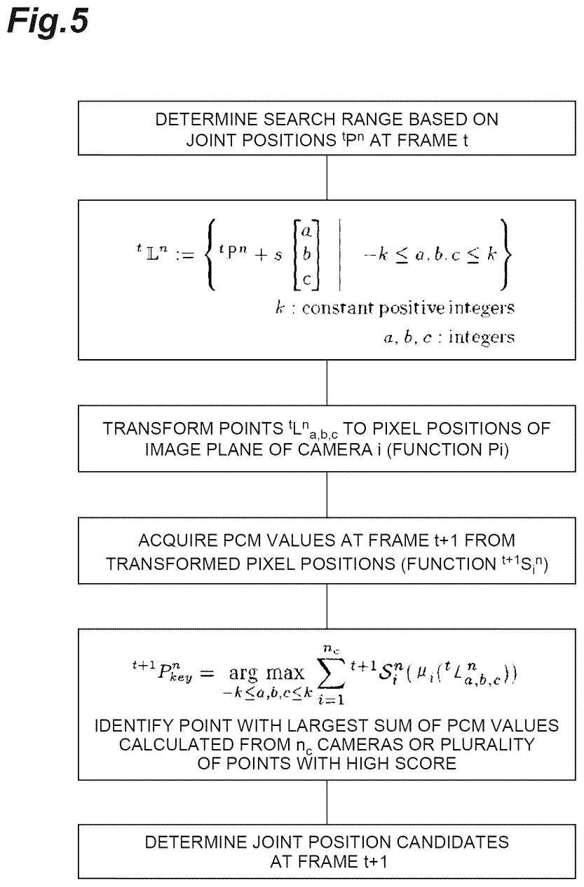

Description will be continued with reference to FIG. 5. FIG. 5 is a flowchart illustrating processing steps which are performed by the joint position candidate acquiring unit. The joint position candidate acquiring unit according to this embodiment calculates joint positions and joint angles at a current frame (the frame t+1) using joint position data at a previous frame (the frame t). A process of acquiring the joint angles and the joint positions at the frame t+1 from the joint positions at the frame t is repeatedly performed until t=T is satisfied, whereby video motion capture at all the T frames is performed. Since a change of a joint position in one frame is minute, ^{t+1}Pⁿ is considered to be present near ^{t}Pⁿ, where ^{t}Pⁿ denotes three-dimensional coordinates of a joint position of a joint n at the frame t and ^{t+1}Pⁿ denotes a joint position thereof at the frame t+1. Therefore, (2k+1)³ lattice points (where k is a positive integer) with a spacing s spread from ^{t}Pⁿ are considered, and a set thereof (a lattice space) is expressed as follows.

$$\begin{matrix}[ Math . 3 ] & \\ {}^{t} {n}^{} := \{ {}^{t} {P}^{n} + s [ \begin{matrix}a \\ b \\ c\end{matrix} ] \vert - k \leq a , b , c \leq k \} & ( 1 )\end{matrix}$$

$$k : constant positive integers$$

$$a , b , c : integers$$

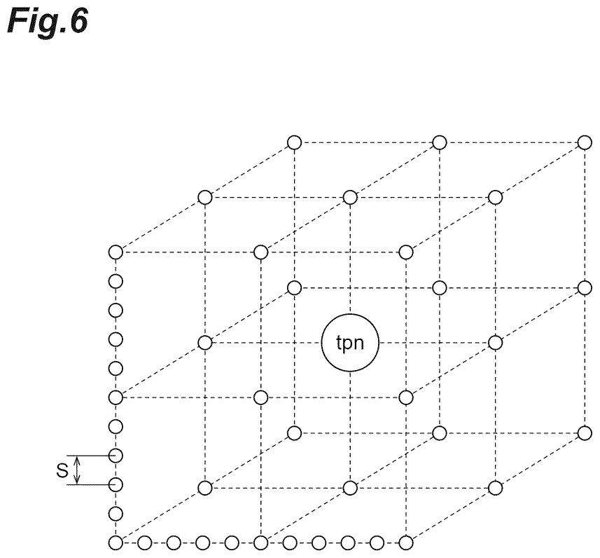

For example, lattice-shaped points of 11×11×11 (k=5) with a spacing s centered on ^{t}Pⁿ as illustrated in FIG. 6 are considered. The distance s between the lattice points is regardless of the size of an image pixel.

The search range based on the joint position ^{t}Pⁿ at the frame t is, for example, a point group in a nearby space of the joint position ^{t}Pⁿ, and is determined by the total number of points (2k+1)³ in the nearby space and the spacing s between the points. In a method of determining the search range, a cubic is illustrated in FIG. 6, but the shape of the search range is not particularly limited, and search may be performed, for example, in a spherical range. Alternatively, a rectangular parallelepiped or a prolate spheroid with a narrowed search range may be used or the center point of the search range is changed from ^{t}Pⁿ to another point based on a change from a joint position at the previous frame, and search may be performed in this setting.

The search range (for example, the center point, a parameter k, or a search width s) can be appropriately set by those skilled in the art. The search range may be changed according to a motion type of a target. The search range may be changed according to a speed or acceleration (for example, a changing speed of a pose of the target) of the motion of the target. The search range may be changed according to a frame rate of a camera used for imaging. The search range may be changed for each part of a joint.

It should be noted that all points in a lattice space ^{t}Lⁿ can be transformed to pixel coordinates on a projection plane of an arbitrary camera using the function μᵢ. When a function of transforming one point ^{t}Lⁿ_{a,b,c} in the lattice space ^{t}Lⁿ to a pixel position on the image plane of the camera i is defined as μᵢ and a function of acquiring a PCM value at the frame t+1 from the pixel position is defined as ^{t+1}Sⁿᵢ, a point at which the sum of the PCM values calculated from n_{c} cameras is maximized can be considered to be a presence position with highest certainty of a joint n at the frame t+1, and ^{t+1}Pⁿ_{key} is calculated by the following expression.

$$\begin{matrix}[ Math . 4 ] & \\ {}^{i + 1} {P}_{key}^{n} = {arg max}_{- k \leq a , b , c \leq k} {\sum }_{i = 1}^{{n}_{c}} {}_{}^{t + 1} {S}_{i}^{n} ( {μ}_{i} ( {}_{}^{t} {∠}_{a , b , c}^{n} ) ) & ( 2 )\end{matrix}$$

This calculation is performed on all the nⱼ joints (18 joints in OpenPose).

It should be noted that each joint position ^{t+1}Pⁿ at the frame t+1 is a function of a joint angle ^{t+1}Q, the joint angle ^{t+1}Q is calculated through optimized calculation based on inverse kinematics as expressed by Expression (3), and the joint position ^{t+1}Pⁿ is calculated through forward kinematics calculation.

$$\begin{matrix}[ Math . 5 ] & \\ {}^{t + 1} Q = arg min {\sum }_{n = 1}^{{n}_{j}} \frac{1}{2} {}_{}^{t + 1} {W}_{}^{n} {‖ {}^{i + 1} {P}_{key}^{n} - {}^{i + 1} {P}^{n} ( {}^{t + 1} Q ) ‖}^{2} & ( 3 )\end{matrix}$$

The sum of PCM values at the predicted positions of the joints is used such that weights ^{t+1}Wⁿ of the joints in the optimized calculation based on inverse kinematics are defined as follows.

$$\begin{matrix}[ Math . 6 ] & \\ {}_{}^{t + 1} {W}_{}^{n} = {\sum }_{i = 1}^{{n}_{c}} {}_{}^{t + 1} {S}_{i}^{n} ( {μ}_{i} ( {}^{i + 1} {P}_{key}^{n} ) ) & ( 4 )\end{matrix}$$

The joint positions acquired in real time or in non-real time by the joint position acquiring unit are stored as time-series data of the joint positions in the storage unit. In this embodiment, the joint positions acquired in real time or in non-real time by the joint position acquiring unit are smoothed by the smoothing processing unit, and smoothed joint positions are generated.

For example, an algorithm described in Non-Patent Literature 17 can be used for the optimized calculation based on inverse kinematics. As the technique of optimized calculation based on inverse kinematics, several techniques are known to those skilled in the art, and a specific optimized calculation technique is not particularly limited. A preferable example thereof is a numerical analysis method based on a gradient method. Expression (4) for defining weights of the joints in optimized calculation based on inverse kinematics is a preferable aspect and is merely an example. For example, in this embodiment, the smoothing processing unit uniformizes the weights of the smoothed joint positions for all the joints and performs the optimized calculation based on inverse kinematics. In performing the optimized calculation based on inverse kinematics, it should be understood by those skilled in the art that constraint conditions can be appropriately given.

In the aforementioned search technique, the search range depends on the lattice spacing s, and thus a point with a highest PCM score cannot be found when such a point is present between a lattice point and a lattice point. In this embodiment, the optimized calculation based on inverse kinematics may be performed by searching for a position with a high PCM score with a plurality of points out of all the lattice points as a joint position point group instead of finding only a lattice point with a highest PCM score using Expression (2). The joint position point group is, for example, seven points. The numerical value of 7 is determined based on the prediction that a point with a high likelihood is present before and after and above and below the maximum point calculated using Expression (2) in the same way.

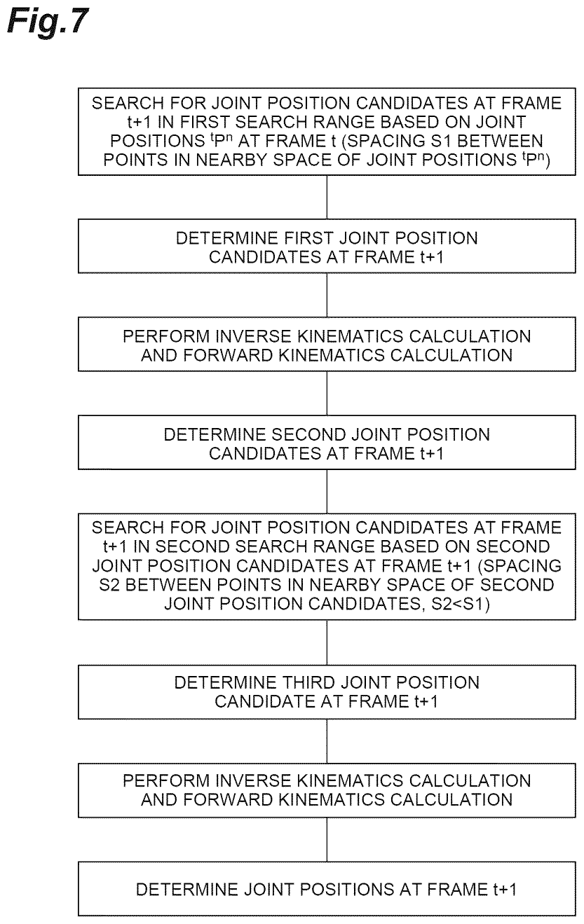

The joint positions may be acquired using different lattice spacings s. In one embodiment, video motion capture in all the T frames is performed by performing search for joint position candidates and optimized calculation based on inverse kinematics two times while changing the value of s to 20 mm and 4 mm and repeating a process of acquiring the joint angles and positions at the frame t+1 from the joint positions at the frame t until t=T is satisfied. Accordingly, it is possible to make a search speed and search precision compatible with each other. FIG. 7 illustrates a joint position acquiring step using different lattice spacings.

First, search for joint position candidates at the frame t+1 in a first search range (a spacing s1 in a nearby space of a joint position ^{t}Pⁿ) based on the joint position ^{t}Pⁿ at the frame t is performed. The spacing s1 is, for example, 20 mm. In this step, a first joint position candidate at the frame t+1 is acquired. The optimized calculation based on inverse kinematics and the forward kinematics calculation are performed using the first joint position candidate, and a second joint position candidate at the frame t+1 is acquired.

Subsequently, search of joint position candidates at the frame t+1 in a second search range (a spacing s2 between points in the nearby space of the second joint position candidate, where s2<s1) based on the second joint position candidates at the frame t+1 is performed. The spacing s2 is, for example, 4 mm. In this step, a third joint position candidate at the frame t+1 is acquired. The optimized calculation based on inverse kinematics and the forward kinematics calculation are performed using the third joint position candidate, and joint angles and joint positions at the frame t+1 are acquired.

In this embodiment, the search range is determined based on the joint positions acquired at the previous frame t, but joint positions acquired at one or more frames previous to the frame t or one or more frames subsequent to the frame t+2 may be used in addition to or instead of the joint positions acquired at the previous frame t. For example, when joint positions are acquired in real time, the search range may be set based on the joint positions at the frame t−1 or a frame previous by two frames such as the frame t−2. Search for keypoint positions may be individually performed through parallel calculation at even frames and odd frames and a smoothing process may be performed on the alternate keypoint positions.

In calculation of Expression (2), likelihoods to be evaluated are indices indicating a degree of precision of motion capture. A threshold value may be set for the likelihoods, and tracking of a pose of a target may be considered to fail and search may be performed with the broadened search range for the joint position candidates when the likelihood is lower than the threshold value. This process may be performed on some parts of the pose of the whole body or may be performed on the whole body. When a keypoint is temporarily lost due to occlusion or the like, a trace of the joint position of the part of which tracking has failed due to occlusion may be recovered in offline analysis by determining a heat map of the same target in the future and tracing back therefrom using continuity of a motion. Accordingly, it is possible to minimize a loss due to occlusion.

As described above, in the method of searching for a point in a three-dimensional space with a maximum PCM score according to this embodiment, a point group in the three-dimensional space is projected onto a two-dimensional plane, PCM scores of the pixel coordinates thereof are acquired, a sum thereof (a PCM score) is calculated, and a point with a highest PCM score in the point group is set as a joint position candidate for a three-dimensional point with the maximum PCM score. Calculation of projecting the three-dimensional point onto each camera plane and calculating a PCM score thereof is light. Search for a joint position candidate in this embodiment realizes reduction of a calculational load by limitation of the search range using information of the previous frames and re-projection of a three-dimensional position of a lattice point in the search point onto a two-dimensional image (PCM) and exclusion of an outlier.

### [E] Smoothed Joint Position Acquiring Unit

Since a time-series relationship is not considered for acquisition of a PCM used for the joint position acquiring unit and the optimized calculation based on inverse kinematics, it is not guaranteed that an output joint position is temporally smooth. A smoothed joint position acquiring unit of the smoothing processing unit performs a smoothing process in consideration of temporal continuity using time-series information of joints. For example, when joint positions acquired at the frame t+1 are smoothed, the joint positions acquired at the frame t+1, the joint positions acquired at the frame t, and the joint position acquired at the frame t−1 are typically used. Pre-smoothing joint positions are used as the joint positions acquired at the frame t and the joint positions acquired at the frame t−1, but smoothed joint positions may be used. When the smoothing process is performed in non-real time, joint positions acquired at a later time, for example, joint positions acquired at a frame subsequent to the frame t+2, may be used. The smoothed joint position acquiring unit may not use successive frames. In order to simplify calculation, smoothing is first performed without using body structure information. Accordingly, the link length which is a distance between neighboring joints is not stored. Subsequently, smoothing with fixed link lengths is performed using the smoothed joint positions by performing the optimized calculation based on inverse kinematics using the again skeletal structure of the target again and acquiring the joint angles of the target.

The smoothed joint position acquiring unit performs temporal smoothing of the joint positions using a low-pass filter. A smoothing process using a low-pass filter is performed on the joint positions acquired by the joint position acquiring unit, the smoothed joint positions are set as target positions of the joints, and the optimized calculation based on inverse kinematics is performed. Accordingly, smoothness of temporal changes of the joint positions can be realized under a skeleton condition in which the inter-joint distances are invariable.

The smoothing processing unit will be described below in more detail. In this embodiment, an IIR low-pass filter shown in Table 3 is designed and the smoothing process using a low-pass filter is performed on the joint positions. A value of a cutoff frequency is a value which can be appropriately set by those skilled in the art, and can empirically employ the values in Table 3. Parameters of a smoothing filter may be adjusted according to a motion type to be measured or a frame rate of a camera to be used.

TABLE 3
IIR Low Pass Filter Design

| | |
|---|---|
| Filter Order | 6 |
| Cutoff Frequency | 6 Hz |
| Sample Rate | 60 Hz |

In characteristics of a low-pass filter, a delay of 3 frames corresponding to half a filter order occurs in acquisition of joint positions using the low-pass filter, and thus there is a problem in that the low-pass filter cannot be applied for 3 frames after update of the joint angles has been started. In this embodiment, by setting the joint positions at a first frame to those at a minus-second frame, a minus-first frame, and a zeroth frame before applying of the filter, a smoothing process of smoothing the joint positions at all the frames with a delay of a calculation time corresponding to 2 frames and with a less spatial error can be performed.

When the joint positions calculated using the filter are used as an output of video motion capture, temporal smoothness of the joints is achieved, but a condition in which the distances between neighboring joints are fixed may collapse. In this embodiment, the joint positions after applying the low-pass filter thereto are set as target joint positions of the joints again, and the optimized calculation based on inverse kinematics is performed thereon again. Expression (3) can be used for the optimized calculation based on inverse kinematics, and the optimized calculation based on inverse kinematics is performed with the weights for all the joints constant (to which the present disclosure is not limited). Accordingly, smoothness of temporal changes of the joint positions to which the low-pass filter is applied can be achieved under the skeleton condition in which the inter-joint distances are invariable. Movable ranges of the joint angles may be added as a constraint condition of the inverse kinematics calculation.

The output of the smoothing processing unit includes, for example, joint angle information, a skeletal structure, and joint position information which can be uniquely calculated from the two types of information. For example, at the time of display of CG, a motion of a body is displayed through forward kinematics calculation using the joint angle information and the skeletal structure file of the body. The information included in the output of the smoothing processing unit may be stored in the storage unit.

### [F] Preprocessing Unit

### [F-1] Rotation of Input Image

In calculation of a heat map, precision in an image in which a person adopts a lying pose or a pose close to a handstand may be lower than that in an image in which a person stands upright. This is because an estimation error of a lower half of a body increases in a handstand or an inverting motion such as a cartwheel of a target due to a bias of data in which many images close to upright standing are included in learning data used by the heat map acquiring unit. In this case, images are rotated according to a body tilt of a target at the previous frames such that the target appears in a pose as close to upright standing as possible. In this embodiment, the PCM score of the lower half of a body is acquired from rotated images.

In general, when it is known that precision of heat map information deteriorates greatly when a target adopts a predetermined first pose set (for example, a lying pose and a handstand) and the precision of heat map information is high when the target adopts a predetermined second pose set (for example, upright standing), it is determined whether a pose of the target is included in the first pose set based on a body tilt of the target in an input image, the input image is rotated such that the pose of the target becomes a pose (upright standing) included in the second pose set, and heat map information is acquired. Particularly, when heat map information is acquired in real time, determination of the body tilt of the target is performed based on an input image at a previous frame. The idea that an input image is rotated to acquire heat map information is a technique which can be generally applied to the heat map acquiring unit independently from motion capture according to this embodiment. Rotation of an input image may not be needed through accumulation of learning data and improvement of a convolutional neural network (CNN). When a movable camera is used, rotation of an input image may not be needed by physically rotating the camera according to a motion of a target and acquiring the function uj for each frame.

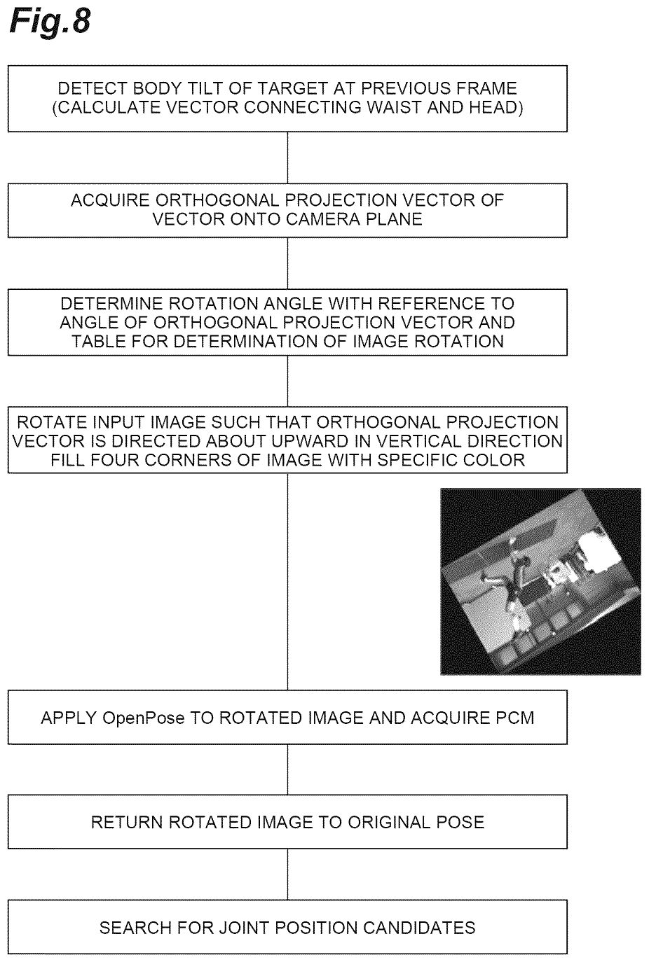

A step of rotating an input image and acquiring a PCM score will be described below with reference to FIG. 8. A body tilt of a target (a tilt of a trunk in one aspect) is detected in an input image at the frame t. For example, a vector connecting the wrist and the neck of the target is calculated. Specifically, three-dimensional coordinate positions of the pelvis joint and the neck joint of the skeletal model in the left part of FIG. 4 are calculated. The body tilt (an angle when the vector connecting the waist and the neck is orthogonally projected onto a camera) of the target in a camera i at the frame t is calculated using the function ui of transforming a three-dimensional point to a pixel position on an image plane of the camera i.

It is determined whether an image rotating process is to be performed based on the body tilt of a target. In this embodiment, an image at the frame t+1 is rotated such that the orthogonal projection vector is directed upward according to the acquired body tilt (the angle of the orthogonal projection vector). For example, a plurality of rotation angle sets (for example, 0 degrees, 30 degrees, 60 degrees, 90 degrees, . . . , and 330 degrees in scales of 30 degrees) and angle ranges corresponding to the rotation angles (for example, a range of 15 degrees to 45 degrees is correlated with 30 degrees) are set in advance and are stored as a table for determining rotation of an input image in the storage unit. The angle range corresponding to the body tilt of the target (the angle of the orthogonal projection vector) at the previous frame is determined with reference to the table, and the input image is rotated by an angle corresponding to the determined angle range to acquire a PCM. When a heat map is acquired offline, a PCM for each rotation angle may be acquired and stored in the storage unit and a PCM may be selected according to the angle of the orthogonal projection vector. In order to easily input the rotated image to a network of OpenPose, a process of filling the background (for corners) with black is performed. OpenPose is applied to the rotated image, and a PCM of the lower half of the target is calculated. The rotated image along with the PCM is returned to the original posture of the image. Then, joint position candidates are searched for. The previous frame used to determine rotation of an input image may be a frame prior to the frame t−1 as well as the frame t.

### [F-2] Other Preprocessing

The preprocessing is not limited to the process of rotating an input image according to a body tilt of a target. Examples of the preprocessing which is performed using three-dimensional position information of one or more targets at the previous frame include trimming or/and reduction, mask processing, camera selection, and stitching.

Trimming is a process of trimming an image with reference to a position on an image of a target at the previous frame and calculating a PCM of only the trimmed part. To shorten a calculation time of a PCM using trimming is advantageous for acquiring a motion of the target in real time. A bounding box which will be described in detail in the next chapter serves as trimming. When an input image is sufficiently large, PCM preparation precision of OpenPose may not change even by reducing an image. Accordingly, it is possible to shorten the calculation time of a PCM through reduction of an image.

Mask processing as the preprocessing is a process of applying mask processing to a person other than a target and calculating a PCM of the target when the person other than the target or the like is included in the input image. By performing mask processing, it is possible to prevent mixing of PCMs of a plurality of targets. Mask processing may be performed by the joint position acquiring unit after the PCM has been calculated.

Camera selection is a process of selecting an input image used for motion acquisition or motion analysis of a target by selecting a camera when the moving image acquiring unit includes a plurality of cameras. For example, when motion capture using a plurality of cameras is performed in a field of a wide range, a camera predicted to image a target is selected in the preprocessing and motion capture is performed using an input image from the selected camera, instead of performing motion acquisition or motion analysis using information from all the cameras which are used. Stitching of an input image may be performed as the preprocessing. Stitching is a process of joining camera images using acquired camera parameters to synthesize of a single seamless image when there is an overlap area of viewing angles of the cameras. Accordingly, even when a target appears partially in an end portion of an input image, it is possible to excellently estimate a PCM.

[G] Flow Until Positions of Keypoints of Target are Acquired from Input Image

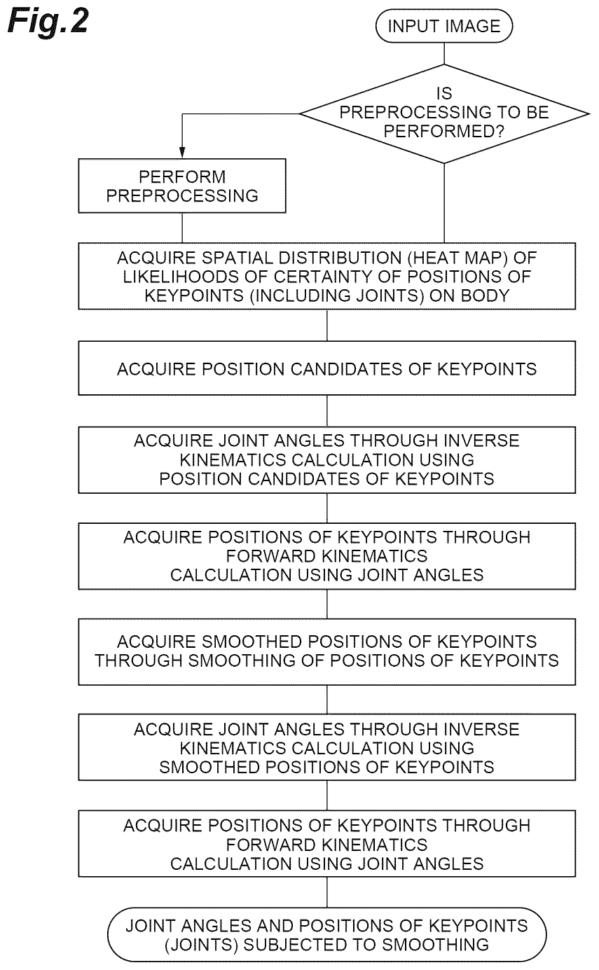

Steps until joint angles and positions of keypoints are acquired from an input image according to this embodiment will be described below with reference to FIG. 2. A motion of a target is imaged by a plurality of synchronized cameras, and an RGB image is output at a predetermined frame rate from each camera. The processing unit determines whether preprocessing is to be performed when the input image is received. The preprocessing is, for example, determining whether an image is to be rotated. When it is determined that an image is to be rotated based on predetermined determination criteria, a heat map is acquired in a state in which the input image has been rotated. When it is determined that an image is not to be rotated, a heat map is acquired based on the input image.

In all the keypoints of a body, a spatial distribution of likelihoods of certainty of the positions of the keypoints of the body (a heat map) is generated and is transmitted to the processing unit. The processing unit performs search for position candidates of the keypoints. In one aspect, when a heat map generated from an input image at the frame t+1 is received, a search range is set based on the positions of the keypoints at the frame t, and position candidates of the keypoints are searched for. The same process is performed on all the joints, and joint position candidates of all the joints are acquired.

Optimized calculation based on inverse kinematics is performed on the position candidates of all the keypoints. The position candidates of the keypoints and the joints (keypoints) of the skeletal model are correlated, and the skeletal model is adapted to a skeletal model specific to the target. Joint angles and positions of the keypoints are acquired by performing optimized calculation based on inverse kinematics and forward kinematics calculation based on the position candidates and the weights of the keypoints.

Temporal movements of the joint positions are smoothed by performing a smoothing process on the acquired positions of the keypoints using the joint positions at the previous frame. Joint angles of the target are acquired by performing optimized calculation based on inverse kinematics using the smoothed positions of the keypoints, and joint positions of the target are acquired by performing forward kinematics calculation using the acquired joint angles.

In this embodiment, a point with a highest PCM score is considered to be a most appropriate pose at the current frame, joint position candidates are acquired, and optimized calculation based on inverse kinematics and smoothing using a low-pass filter are performed in a subsequent process while allowing a decrease of the PCM score. By performing optimized calculation based on inverse kinematics in consideration of the skeletal structure of the target and temporal continuity of the positions of the keypoints, it is possible to decrease an estimation error of the positions of the keypoints.

In motion capture according to this embodiment, smooth motion measurement comparable with optical motion capture according to the related art is performed by performing three-dimensional reconstruction of joint positions estimated from images of a plurality of cameras using deep learning in consideration of a skeletal structure of a human being and continuity of a motion. The following advantages are achieved by causing the joint position candidate acquiring unit according to this embodiment to employ the algorithms indicated by Expressions (1) to (4). An ambiguous joint position with a spatial expansion in a heat map is optimized with reference to a skeleton shape of a human being (by performing optimized calculation based on inverse kinematics). In searching for joint position candidates, a plurality of pieces of heat map information with a spatial expansion acquired from input images from the cameras are used without any change, and then joint positions are calculated by optimized calculation based on inverse kinematics using the joint position candidates in consideration of the skeletal structure of a target.

In the skeletal structure, when displacement of a degree of freedom of a skeleton which cannot be determined using only the positions of the keypoints acquired using the heat map information needs to be determined, the determination may be performed through optimization using preliminary knowledge as a condition. For example, an initial angle is given using preliminary knowledge that a hand or a foot is present at a tip of a wrist or an ankle. The initial angle is changed for each frame when information of a hand or a foot is acquired, and an angle of a hand or a foot is not changed from the angle at the previous frame but is fixed when information of the hand or the foot is not acquired. Optimized calculation based on inverse kinematics may be performed using preliminary knowledge that degrees of freedom of a hand and a foot are weighted and limited according to a movable range of an elbow or a knee such that inversion of the wrist and the ankle is prevented and a body does not penetrate the ground.

### [II] Multiple-Person Motion Capture System

### [A] Summary of Motion Capture System

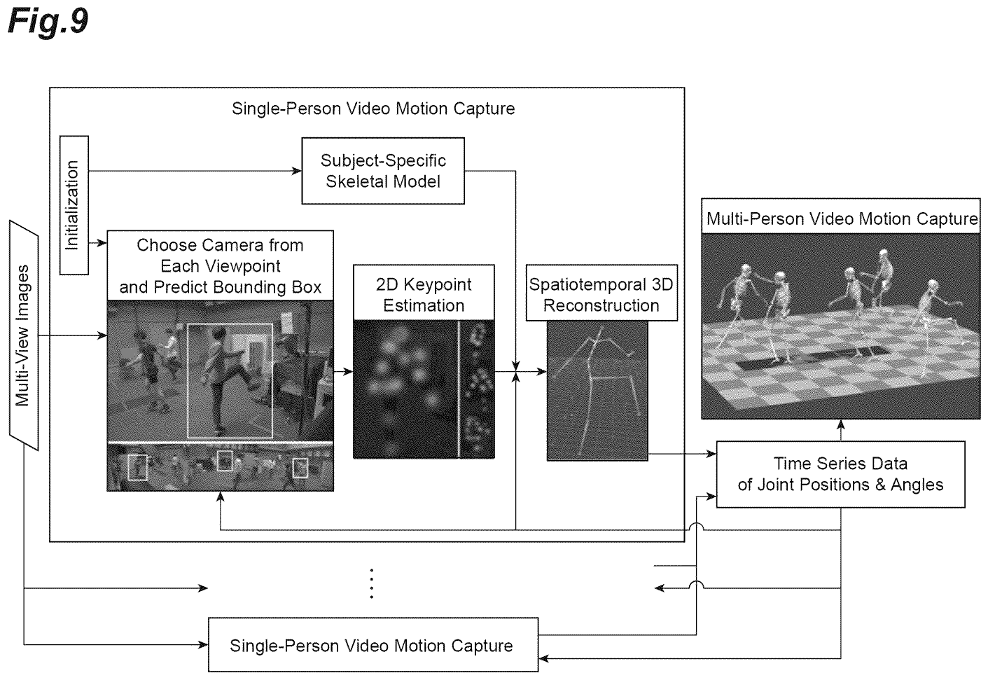

Multiple-person motion capture system according to this embodiment uses top-down pose estimation. FIG. 9 is a flowchart illustrating multiple-person video motion capture according to the embodiment. Multiple-viewpoint images captured by a plurality of cameras are used as input images. Each input image includes a plurality of persons, and video motion capture is independently performed on each person by surrounding each person with a bounding box. When a plurality of cameras are provided for each viewpoint, one camera is selected for each viewpoint, and a bounding box surrounding a target person is determined in the selected camera image. Heat map information of keypoints is acquired based on image information in the bounding box. In this embodiment, a heat map of each keypoint is estimated an HRNet (https://github.com/HRNet) which is one top-down pose estimator. In initial setting, a skeletal model specific to each person is set, and three-dimensional reconstruction of keypoints is performed using the heat map information acquired from the camera images and skeleton parameters. Description in Chapter I can be referred to for the skeleton parameters specific to each person. By acquiring 3D positions of keypoints and joint angles at each time point, motion capture of the target is performed based on time-series information of the 3D positions of the keypoints and the joint angles (time-series information of a 3D pose). Acquisition of the 3D positions of the keypoints and the joint angles at each time point is performed in parallel on multiple persons, and motion capture of multiple persons is performed. In one aspect, a skeletal structure corresponding to the time-series information of the 3D positions of the keypoints and the joint angles (time-series information of the 3D pose) is displayed on the display together.

FIG. 10 is a flowchart illustrating steps of processing an input image according to the embodiment. A motion capture system according to this embodiment is different from the motion capture system described in the previous chapter in that a step of determining a bounding box is provided before a heat map of each keypoint is acquired. That is, a bounding box surrounding a target in an input image (an RGB image) is determined, and the heat map acquiring unit acquires a heat map of the target based on image information in the bounding box. Estimation of a pose is performed using heat map information (a spatial distribution of likelihoods of certainty of positions of keypoints) and the skeletal model. Basically, the technique described in the previous chapter can be used for acquisition of positions of keypoints.

Three-dimensional motion reconstruction according to this embodiment is performed using n_{c} cameras disposed near np persons. The cameras are synchronized and calibrated. When an imaging space of a camera is a wide space, a plurality of cameras with different viewing fields may be disposed adjacent to each other for each viewpoint in order to prevent a problem that a target is cut off by the camera. In this case, when the number of viewpoints is defined as nᵥ, a camera set disposed at a viewpoint v is defined as Cᵥ, and the number of cameras at the viewpoint v is defined as n_{Cv}, the number of cameras is the same as follows.

$$\begin{matrix}[ Math . 7 ] & \\ {n}_{c} = {\sum }_{υ}^{{n}_{v}} {n}_{{C}_{v}} & ( 1 )\end{matrix}$$

At each viewpoint v, one camera is selected out of n_{Cv} cameras, and 2D positions of the keypoints are estimated using an image of the selected camera. More specifically, a predetermined bounding box is set in the image of the selected camera, and heat maps of the keypoints are acquired using pixel information in the bounding box. This camera system is an example, and one camera may be disposed for each of a plurality of viewpoints to constitute a camera system.

### [B] Initial Setting

A target is imaged by a plurality of cameras. An area of a target person in each image is searched for, and a bounding box is prepared. A person area at the time of initial setting can be searched for using a person detector such as Yolov3, a pose estimator corresponding to multiple persons such as OpenPose, an epipolar constraint using camera parameters, an individual identifier using face recognition or costume recognition, or the like. Alternatively, an area of each person may be manually given. A plurality of persons may be included in a bounding box.

Heat maps of keypoints of one target in the bounding box are calculated using a top-down pose estimator (for example, HRNet), and positions of the keypoints are detected. For example, center coordinates of the heat maps are estimated to be 2D positions of the keypoints. By detecting the 2D positions from a plurality of viewpoints, three-dimensional reconstruction of a 3D position of one keypoint is performed using a plurality of 2D positions of the keypoint, and an initial 3D pose and a skeleton parameter of one target (an inter-joint distance in a three-dimensional space) are calculated. The skeleton parameter may be calculated from images of a plurality of cameras at one time or may be calculated from camera images at a plurality of times to reduce an influence of an error. The skeleton parameter may be measured in advance. The skeleton parameter may include a movable range of each joint angle.

When it is determined that initialization (estimation of the initial 3D pose and the skeleton parameters) has failed, the aforementioned step is performed in another imaging time. As an index of the determination, a value of a heat map when a three-dimensionally reconstructed position of a keypoint is projected onto an image plane, an error between a coordinate value when the 3D position of the keypoint is re-projected onto the image plane and a coordinate value initially estimated as the 2D position of the keypoint, coefficients of the skeleton parameters, and the like can be used.

At the time of initial setting, three-dimensional reconstruction of each keypoint is performed using the 2D position of the keypoint acquired directly from heat map information of each keypoint, and then the 3D pose is estimated using heat map information (a spatial distribution of likelihoods of certainty of positions of keypoints) similarly to the technique described in the previous chapter.

### [C] Determination of Bounding Box in Input Image

The motion capture system according to this embodiment uses top-down pose estimation and determines a bounding box before calculating a heat map of each keypoint. In this embodiment, a size and a position of the bounding box are appropriately predicted using 3D position information of keypoints acquired in different frames. With the video motion capture according to this embodiment, it is possible to perform motion capture with high precision equivalent to optical motion capture. When a frame rate is sufficiently high, a current 3D pose of a target can be predicted based on a calculated previous 3D pose or calculated previous 3D poses (3D motions in the past). The appropriate size and position of the bounding box can be calculated using a perspective projection transformation (using the matrix μᵢ) based on a predicted position of the 3D pose of the target.

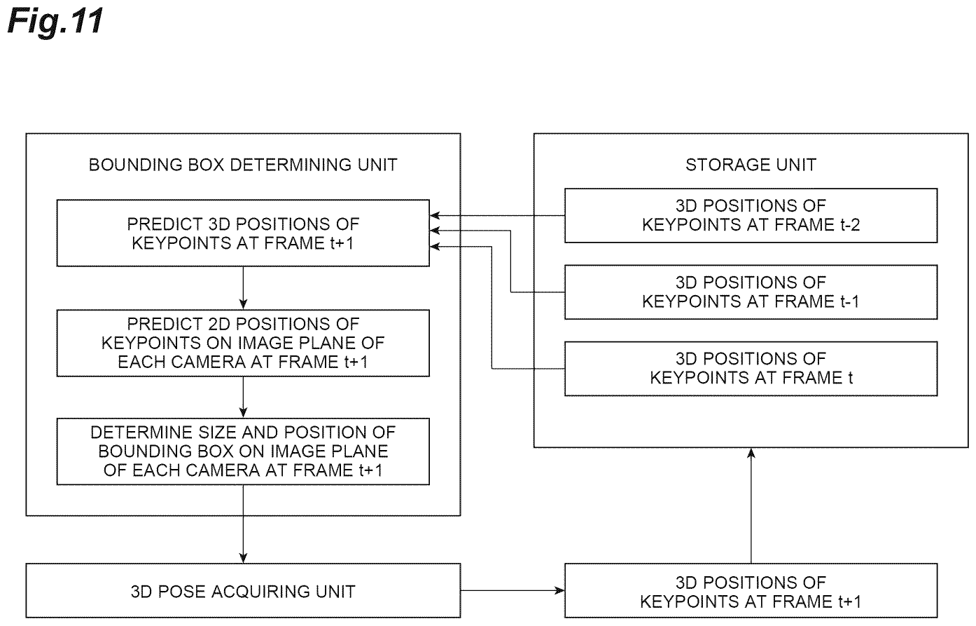

Determination of a bounding box will be described below with reference to FIG. 11. It is assumed that a 3D pose (3D positions of keypoints) of a target at the frame t−2, the frame t−1, and the frame t are acquired and the 3D pose of the target at the frame t+1 is going to be acquired. Determination of a bounding box includes predicting 3D positions of keypoints at the frame t+1, predicting 2D positions of the keypoints on an image plane of each camera at the frame t+1 using the predicted 3D positions of the keypoints, and determining a size and position of the bounding box on the image plane of each camera at the frame t+1 using the predicted 2D positions (coordinates) of the keypoints. That is, the bounding box determining unit includes a 3D position predicting unit configured to predict a 3D position of each keypoint at the next frame, a 3D position predicting unit configured to predict a 2D position of each keypoint at the next frame, and a bounding box size and position determining unit configured to determine a size and position of the bounding box at the next frame.

The 3D position predicting unit for keypoints calculate a predicted 3D position of each keypoint at the frame t+1, for example, using the 3D positions of the keypoint at the frame t−2, the frame t−1, and the frame t. The frame t−2, the frame t−1, and the frame t illustrated in FIG. 11 are merely an example, and frames used to predict a 3D position of the keypoint at the next frame t+1 are not limited to the frame t−2, the frame t−1, and the frame t. For example, the 3D positions of the keypoint at the frame t−1 and the frame t may be used, or the 3D positions of the keypoint at frames previous to the frame t−2 may be used. The predicted 3D positions of each keypoint at the frame 1, the frame 2, and the frame 3 after initial setting are acquired, for example, using an initial 3D pose, the initial 3D pose and a 3D pose at the frame 1, and the initial 3D pose, the 3D pose at the frame 1, and a 3D pose at the frame 2, respectively.

The 2D position predicting unit for keypoints acquires a predicted 2D position (coordinates) of each keypoint on an image plane of each camera at the frame t+1 by projecting the predicted 3D position of the keypoint at the frame t+1 onto the camera images using a perspective projection transformation. The perspective projection transformation is performed using a function (matrix) μᵢ of transforming an arbitrary three-dimensional point to a pixel position on an imaging plane of the camera i. The function (matrix) μᵢ is acquired through calibration of each camera.

The bounding box size and position determining unit determines a size and position of a bounding box to include the predicted 2D positions of all the keypoints in the camera images. The position of the bounding box is determined, for example, by center coordinates of a rectangular box. It should be noted that the calculation which is performed by the bounding box determining unit is light. In the image at the frame t+1, a 3D pose of a target (3D positions of the keypoints) at the frame t+1 is acquired based on image information of an area surrounded with the bounding box. The 3D positions of the keypoints at the frame t+1 are stored in the storage unit and used to determine a bounding box in the image at the frame t+2.

In one aspect, the bounding box can be determined through the following calculation.

$$\begin{matrix}[ Math . 8 ] & \\ {}_{l}^{t + 1} {B}_{i} = [ \begin{matrix}\{ max ( {[ {μ}_{i} ( {}_{l}^{t + 1} {P}_{pred} ) ]}_{z} ) + min ( {[ {μ}_{i} ( {}_{l}^{t + 1} {P}_{pred} ) ]}_{z} ) \} / 2 \\ \{ max ( {[ {μ}_{i} ( {}_{l}^{t + 1} {P}_{pred} ) ]}_{y} ) + min ( {[ {μ}_{i} ( {}_{l}^{t + 1} {P}_{pred} ) ]}_{y} ) \} / 2 \\ m \{ max ( {[ {μ}_{i} ( {}_{l}^{t + 1} {P}_{pred} ) ]}_{x} ) - min ( {[ {μ}_{i} ( {}_{l}^{t + 1} {P}_{pred} ) ]}_{z} ) \} \\ m \{ max ( {[ {μ}_{i} ( {}_{l}^{t + 1} {P}_{pred} ) ]}_{y} ) - min ( {[ {μ}_{i} ( {}_{l}^{t + 1} {P}_{pred} ) ]}_{y} ) \}\end{matrix} ] & ( 2 )\end{matrix}$$

$${}_{l}^{t + 1} {P}_{pred} = \frac{3}{2} {}_{l}^{t} P - {}_{l}^{t - 1} P + \frac{1}{2} {}_{l}^{t - 2} P \qquad ( 3 )$$

Here, ^{t+1}₁Bᵢ denotes a center position and a size of a person 1 predicted in an image of the camera i at the frame t+1. ^{t1}P, ^{t-1}₁P, and ^{t-2}₁P denote 3D positions of all the joints of the person 1 at the frames t, t−1, and t−2. Here, m is a positive integer for determining a size of a bounding box assumed to include the whole body of the target.

Expression (3) is an expression for calculating predicted 3D positions of joints at the frame t+1. Expression (3) is merely an example, and coefficients or frames which are used are not limited to those in Expression (3). An expression for position prediction may be set based on the assumption that a motion of a target is a constant-acceleration motion, or the expression may be designed based on the assumption that the motion of the target is a constant-velocity motion. The 3D positions at frames prior to the frame t−3 may be used or use of the 3D positions at frames subsequent to the frame t+2 is not excluded. When the 3D positions of the joints at a plurality of frames are used, weights may be appropriately set for values at the frames. The expression may be changed according to a target or a type of a motion.

Expression (2) is an expression for determining a size and position of a bounding box and is an example. In Expression (2), a maximum x coordinate value, a minimum x coordinate value, a maximum y coordinate value, and a minimum y coordinate value are acquired from coordinates of all the keypoints on an image plane of each camera, the size of the bounding box and reference longitudinal and lateral sizes are determined from the coordinate values, and the center coordinate value of these coordinate values is set as the position of the bounding box. The size of the bounding box is determined from the longitudinal and lateral sizes and a constant m. The range of m is not limited, and for example, m ranges from 1.1 to 1.5 or, for example, m=1.25 is used. It should be understood that the range of m can be appropriately set by those skilled in the art. When the value of m is small and particularly a predicted 3D position of a keypoint is erroneously estimated, a part of a body may not be included in the bounding box. When only an eye or a wrist is included as the keypoints and m is set to a small value, a head or a fingertip may not be included in the bounding box. On the other hand, when the value of m is large, the merit of use of the bounding box may decrease. For example, the likelihood that another target will be included in the bounding box increases.

### [D] 3D Pose Acquiring Unit

### [D-1] Acquisition of Heat Map of Keypoint

In this embodiment, a heat map of each keypoint is acquired using an HRNet model having been trained with a coco data set. In this embodiment, an input image can be resized to a predetermined dimension W′×H′×3(RGB) according to a top-down pose estimator which is used. For example, with an HRNet pose estimator, W′×H′=288×384 is set. The number of keypoints nₖ is 17 and includes 12 joints (shoulders, elbows, wrists, a waist, knees, and ankles) and 5 keypoints (eyes, ears, and a nose). The top-down pose estimator for generating a heat map corresponding to each keypoint is known, and a pose estimator which can be used in this embodiment is not limited to the HRNet model.

### [D-2] Determination of Rotation or Tilt of Bounding Box

The HRNet used in this embodiment is trained based on the premise that a body is not excessively tilted. Accordingly, when a body is much tilted with respect to the vertical direction (for example, a handstand or a cartwheel), estimation of a pose may fail. In this embodiment, a heat map of each keypoint is more accurately estimated by rotating the bounding box. A rotation angle of the bounding box is derived from a slope of a prediction vector connecting the trunk and the head.

$$\begin{matrix}[ Math . 9 ] & \\ {}_{l}^{t + 1} {B}_{i}^{′} = \frac{π}{2} - a tan 2 ( {[ {μ}_{i} ( {}_{l}^{t + 1} {P}_{pred}^{n ( 1 )} ) ]}_{y} - {[ {μ}_{i} ( {}_{l}^{t + 1} {P}_{pred}^{n ( 4 )} ) ]}_{y} , {[ {μ}_{i} ( {}_{l}^{t + 1} {P}_{pred}^{n ( 1 )} ) ]}_{x} - {[ {μ}_{i} ( {}_{l}^{t + 1} {P}_{pred}^{n ( 4 )} ) ]}_{x} ) & ( 4 )\end{matrix}$$

In this expression, n denotes joint positions of a human skeletal model. Numerals correspond to positions indicated by numerals in the left part of FIG. 4. In one aspect, heat maps of 11 keypoints (shoulders, elbows, wrists, eyes, ears, and a nose) are calculated using image information of an area surrounded with a rotated bounding box. Rotation of the bounding box may be rotation relative to the image or the bounding box may be set on a rotated input image. Rotation of an input image in the previous chapter can be referred to for rotation of the input image.

### [D-3] Selection of Camera

In this embodiment, since a plurality of cameras with different viewing fields are provided for one viewpoint, a camera most appropriately imaging a target person is selected using estimation of 2D positions of keypoints. Selection of a camera is performed, for example, by the following expression using predicted joint positions. Variable I denotes a resolution of a camera image.

$$\begin{matrix}[ Math . 10 ] & \\ i ( v , t , l ) = {argmin}_{i ∈ {C}_{v}} \{ {( {[ {μ}_{i} ( {}_{l}^{t + 1} {P}_{pred}^{n ( 1 )} ) ]}_{x} - \frac{{I}_{x}}{2} )}^{2} + {( {[ {μ}_{i} ( {}_{l}^{t + 1} {P}_{pred}^{n ( 1 )} ) ]}_{y} - \frac{{I}_{y}}{2} )}^{2} \} & ( 5 )\end{matrix}$$

### [D-4] Acquisition of Joint Position

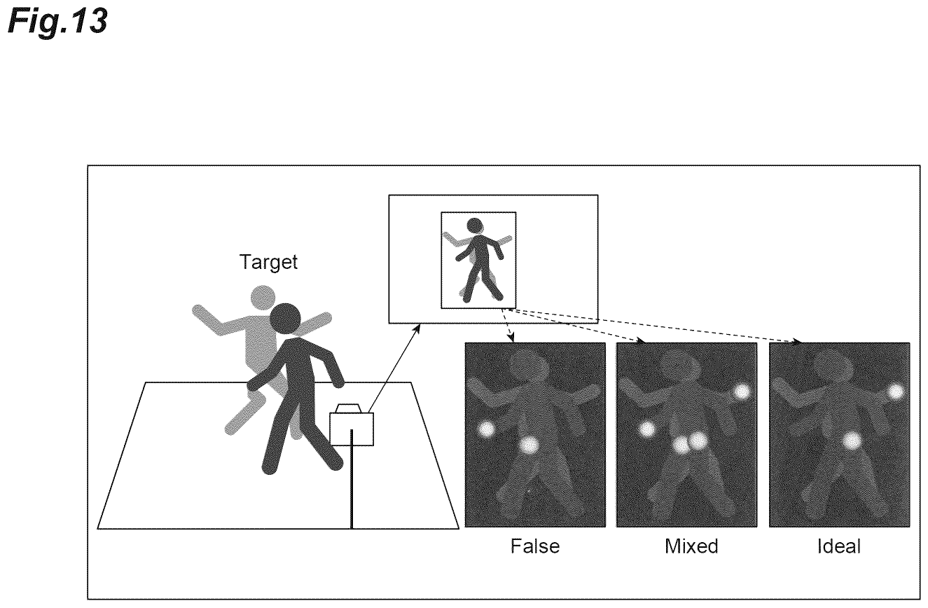

In estimating a 3D pose, a 3D position of each keypoint is generally acquired by three-dimensionally reconstructing a 2D position of the keypoint detected from each camera. More specifically, for example, the center coordinate of a heat map of each keypoint in each camera image is estimated to be a 2D position of the keypoint, and a 3D position of the keypoint is acquired using the 2D position. However, with this simple technique, estimation of a 3D pose will fail due to erroneous detection of the keypoint, for example, in a strict occlusion environment (see FIG. 13). It should be noted that a heat map is a spatial distribution of likelihoods of certainty of the position of the keypoint and indicates the likelihood of a correct position of the keypoint even when the 2D position of the keypoint detected from the heat map (the center coordinates of the heat map) is erroneously detected.

Therefore, similarly to the technique in the previous chapter, a search range for acquiring a position candidate (one or more position candidates) of a keypoint is set. In the previous chapter, a nearby space of a keypoint acquired at the frame t is set as the search range. On the other hand, in this embodiment, a nearby space of a predicted position of the keypoint predicted at the frame t+1 is set as the search range. Specifically, a lattice space centered on a predicted 3D position ^{t+1}₁Pⁿ_{pred} of a keypoint at the frame t+1 is set (^{t}Pⁿ in FIG. 6 is replaced with ^{t+1}₁Pⁿ_{pred}), and ^{t+1}₁Lⁿ_{a,b,c} denotes one point in the lattice space.

$$\begin{matrix}[ Math . 11 ] & \\ {}_{l}^{t + 1} {n}^{} := \{ {}_{l}^{t + 1} {P}_{pred}^{n} + s [ \begin{matrix}a \\ b \\ c\end{matrix} ] \vert - k \leq a , b , c \leq k \} & ( 6 )\end{matrix}$$

$$k : constant positive integers$$

$$a , b , c : integers$$

$${}_{l}^{t + 1} {L}_{a , b , c}^{n} ∈ {}_{l}^{t + 1} {n}^{} \qquad ( 7 )$$

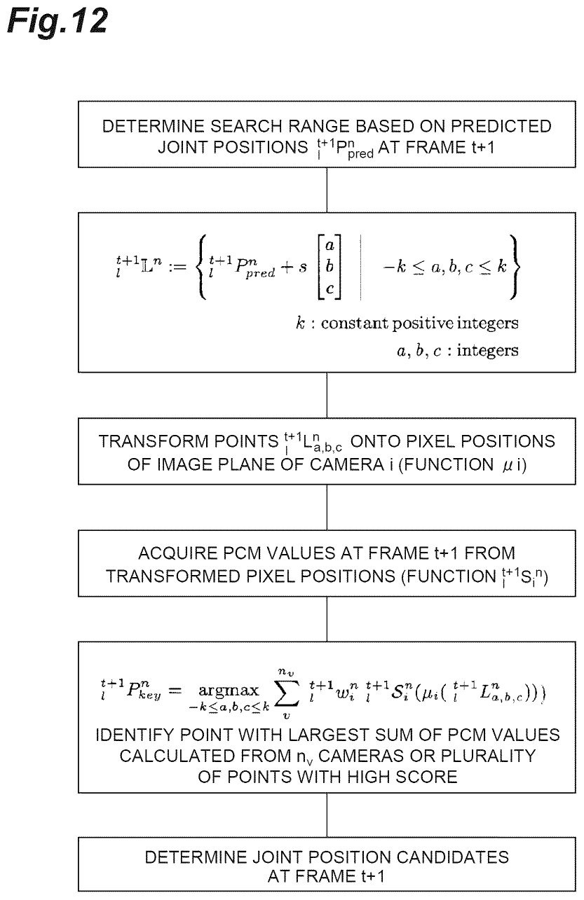

By using a perspective projection transformation, an arbitrary point of 3D coordinates can be projected onto coordinates in an image of the camera i, and a likelihood (a PCM score) corresponding to the coordinates can be acquired. When it is assumed that ^{t+1}₁Pⁿ_{pred} is accurately predicted, a 3D position of the keypoint with the highest likelihood is a lattice point at which the sum of likelihoods (PCM scores) is maximized. Processing steps which are performed by the joint position candidate acquiring unit are illustrated in FIG. 12.

In multiple-person motion capture, there is a likelihood of occurrence of occlusion (see FIG. 13). In this embodiment, it is assumed that reliability of the likelihoods (PCM scores) decreases in an occlusion environment. A weight which is a constant is assigned to the likelihood (PCM score) acquired from heat map information. A position of the keypoint with a highest likelihood is acquired as follows.

$$\begin{matrix}[ Math . 12 ] & \\ {}_{l}^{t + 1} {P}_{key}^{n} = {arg max}_{- k \leq a , b , c \leq k} {\sum }_{υ}^{{n}_{v}} {}_{l}^{t + 1} {ω}_{l}^{n} {}_{l}^{t + 1} {𝒮}_{i}^{n} ( {μ}_{i} ( {}_{l}^{t + 1} {L}_{a , b , c}^{n} ) ) & ( 8 )\end{matrix}$$

$${}_{l}^{t + 1} {ω}_{l}^{n} = \{ \begin{matrix}g & if {μ}_{i} ( {}_{l}^{t + 1} {P}_{pred}^{n} ) is occluded by other {μ}_{i} ( {}^{t + 1} {P}_{pred}^{n} ) \\ 1 & otherwise .\end{matrix} , \qquad ( 9 )$$

Here, ^{t+1}₁Sⁿᵢ(X) is a function for acquiring a likelihood (a PCM score) of a joint n of a person 1 in the camera i at time t+1. g is a constant between 0 and 1 and is appropriately set by those skilled in the art, and for example, g=0.25 is used. An optimal value of g can be changed, for example, depending on an occlusion situation, a part of a joint, or the number of viewpoints.

A joint position of a skeletal model is calculated with reference to the calculated position of the keypoint. In this embodiment, a joint angle of the skeletal model can be optimized using inverse kinematics calculation with the position of the keypoint as a target position with reference to the correlation illustrated in FIG. 4.

$$\begin{matrix}[ Math . 13 ] & \\ {}_{l}^{t + 1} Q = arg min {\sum }_{n}^{{n}_{k}} \frac{1}{2} {}_{l}^{t + 1} {W}_{}^{n} {‖ {}_{l}^{i + 1} {P}_{key}^{n} - {}_{l}^{i + 1} {P}^{n} ‖}^{2} & ( 10 )\end{matrix}$$

$$s . t . {}_{l}^{i + 1} \dot{P} = {}_{l} J {}_{l}^{t + 1} \dot{Q} \qquad ( 11 )$$

$${}_{l}^{t + 1} {W}_{}^{n} = {\sum }_{v}^{{n}_{c}} {}_{l}^{t + 1} {S}_{i}^{n} ( {μ}_{i} ( {}_{l}^{i + 1} {P}_{key}^{n} ) ) \qquad ( 12 )$$

Here, ^{t+1}₁Q denotes a joint angle of a person 1 at time t+1, and ₁J denotes a Jacobian matrix.

Joint positions are calculated by optimized calculation, but temporal continuity of a motion is not reflected in the joint positions. In order to acquire a smooth motion, the joints positions are smoothed using a low-pass filter F including time-series data of the joint positions.

$$\begin{matrix}[ Math . 14 ] & \\ {}_{l}^{t + 1} {P}_{smo} = {}_{l}^{t + 1} ℱ ( {}_{l}^{t + 1} P ) & ( 13 )\end{matrix}$$

However, when a smoothing process is performed, the skeletal model collapses and spatial continuity is lost. Since only link lengths are considered in the inverse kinematics calculation, a movable range of each joint angle is not considered. Therefore, the skeletal model is optimized again by inverse kinematics calculation using the smoothed joint position as a target position.

$$\begin{matrix}[ Math . 15 ] & \\ {}_{l}^{t + 1} {Q}^{′} = arg min {\sum }_{n}^{{n}_{k}} \frac{1}{2} {}_{l}^{t + 1} {W}_{}^{′ n} {‖ {}_{l}^{i + 1} {P}_{smo}^{n} - {}_{l}^{i + 1} {P}^{′ n} ‖}^{2} & ( 14 )\end{matrix}$$

$$s . t . {}_{l}^{i + 1} \dot{{P}^{′}} = {}_{l} J {}_{l}^{t + 1} \dot{{Q}^{′}} \qquad ( 15 )$$

$${Q}^{-} \leq {}_{l}^{t + 1} {Q}^{′} \leq {Q}^{+} \qquad ( 16 )$$

$${}_{l}^{t + 1} {W}_{}^{′ n} = {\sum }_{v}^{{n}_{c}} {}_{l}^{t + 1} {S}_{i}^{n} ( {μ}_{i} ( {}_{l}^{t + 1} {P}_{smo}^{n} ) ) , \qquad ( 17 )$$

Here, Q⁻ and Q⁺ denote a minimum value and a maximum value of a range of motion (RoM). Through this calculation, more appropriate joint position and angle (3D pose) are acquired.

Motion capture of a single target is performed by repeating the aforementioned process (acquisition of a 3D position at each frame). Video motion capture of multiple persons can be realized by performing the same process in parallel on a plurality of targets. The motion capture of multiple persons can be applied, for example, by acquiring a moving image of a competition of team sports (such as soccer, futsal, rugby, baseball, volleyball, or handball) and performing motion capture of each player in competition. Determination of a bounding box described in this embodiment can be applied to pose estimation using an image including a single target as an input image in addition to motion capture of multiple persons.

### [E] Complementation of Motion Capture Flow

Performance of the 3D pose estimator according to this embodiment depends on determination of a target using a bounding box. Accordingly, for example, how to cope with the following cases is important:
(i) a case in which a 3D pose of a target is excessively erroneously estimated (typically a case in which a plurality of targets are very close to each other);
(ii) a case in which a target moves out of a capture volume; and
(iii) a case in which a new target moves into a capture volume.
   In this section, a mechanism for complementing a motion capture flow by detecting occurrence of these events will be described below.

The complementation mechanism includes a second 3D pose estimator or estimation program for estimating a 3D pose of a target without using a bounding box. In one aspect, the second 3D pose estimator is a bottom-up type. The second 3D pose estimator operates in parallel with the 3D pose estimator (a first 3D pose estimator) using a bounding box according to this embodiment. The second 3D pose estimator estimates a 3D pose of a target at each frame or periodically. That is, the motion capture system includes the second 3D pose estimator without using a bounding box in addition to the first 3D pose estimator using a bounding box.

The second 3D pose estimator will be described below. The second 3D pose estimator estimates a person position in each image without using bounding box information by utilizing a person detector (such as Yolo v3) or a multiple-person pose estimator (such as OpenPose) for each camera. Then, the second 3D pose estimator matches the estimated person between the plurality of cameras by utilizing an epipolar constraint or an individual identifier using face recognition, costume recognition, or the like and calculates a 3D position of the estimated person to estimate a 3D pose thereof. Instead of acquiring a 3D pose of a target, the second 3D pose estimator may acquire a position of an approximate space (for example, a rectangular parallelepiped or a circular column) which is three-dimensionally occupied by the target. In this respect, the second 3D pose estimator can be generalized as a 3D position estimator.

The complementation mechanism complements pose estimation performed by the first 3D pose estimator, for example, when the event (i) occurs. When the event (ii) occurs, for example, a PCM score of a first 3D pose estimated by the first 3D pose estimator (a PCM score of a 2D pose projected onto an image plane, for example, a sum of PCM scores calculated by Expression (4) in Chapter I) is calculated and compared with a threshold value, and it is determined erroneous estimation when the PCM score of the first 3D pose is less than the threshold value. At this time, a second 3D pose estimated by the second 3D pose estimator is employed, for example, on the premise that the PCM score of the second 3D pose is greater than the threshold value.

The complementation mechanism may include a comparer and determiner configured to compare a first 3D pose of a target estimated by the first 3D pose estimator using a bounding box with a second 3D pose of the target estimated by the second 3D pose estimator and to determine whether the first 3D pose has been erroneously estimated. Comparison and determination in the comparer and determiner may be performed at each frame or may be performed periodically (for example, one time per second or two times per second).

Examples of the comparison method include comparison of the first 3D pose with the PCM score of the second 3D pose (the PCM score of the 2D pose projected onto an image plane, for example, a sum of PCM scores calculated by Expression (4) in Chapter I), a three-dimensional norm error between the first 3D pose and the second 3D pose, and a degree of coincidence between a position obtained by projecting the first 3D pose onto the two-dimensional image plane and a position obtained by projecting the second 3D pose (a 3D position) onto the two-dimensional image plane. Based on the result of comparison, whether the 3D pose of the target has been erroneously estimated by the first 3D pose estimator is determined using a set determination value.

When it is determined that the 3D pose of the target has been erroneously estimated by the first 3D pose estimator, the bounding box for estimating the 2D pose of the target is corrected based on the 3D pose (the 3D position) estimated by the second 3D pose estimator. When correction is performed based on the second 3D pose, a predetermined condition may be added. For example, the condition may be that a difference between re-projection of the second 3D pose onto the image plane and the 2D pose used to estimate the second 3D pose is less than the determination value. The first 3D pose estimator acquires the 3D pose of the target using the corrected bounding box. For example, when erroneous estimation at the frame t is determined, the bounding box at the frame t is corrected, and the first 3D pose estimator re-calculates the 3D pose at the frame t using the corrected bounding box. Alternatively, when erroneous estimation at the frame t is determined, the first 3D pose estimator calculates the 3D pose at the frame t+1 using the corrected bounding box at the frame t+1. In this way, the complementation mechanism copes with the event (i).

The complementation mechanism determines that the event (ii) has occurred. When the second 3D pose estimator cannot recognize a target, it is determined that the target has moved out of a capture volume (that is, the event (ii) has occurred), and motion capture calculation of the target using the first 3D pose estimator is stopped. The size of a capture volume may be determined in advance, it may be determined that the event (ii) has occurred when the 3D pose departs from the capture volume, and motion capture calculation of the target using the first 3D pose estimator may be stopped.

The complementation mechanism determines that the event (iii) has occurred. When the second 3D pose estimator has recognized a new target, it is determined that the new target moves into the capture volume (that is, the event (iii) has occurred), and the first 3D pose estimator performs system initialization for the new target and performs a motion capture process. The aforementioned description can be referred to for the initialization.

When a target temporarily moving out of the capture volume moves into the capture volume again, this case can be handled as occurrence of the event (iii). In this case, when the newly recognized target and the target of which 3D pose estimation has been stopped with occurrence of the event (ii) are recognized to be the same, skeleton information acquired in advance can be used for pose estimation of the newly recognized target in the first 3D pose estimator.

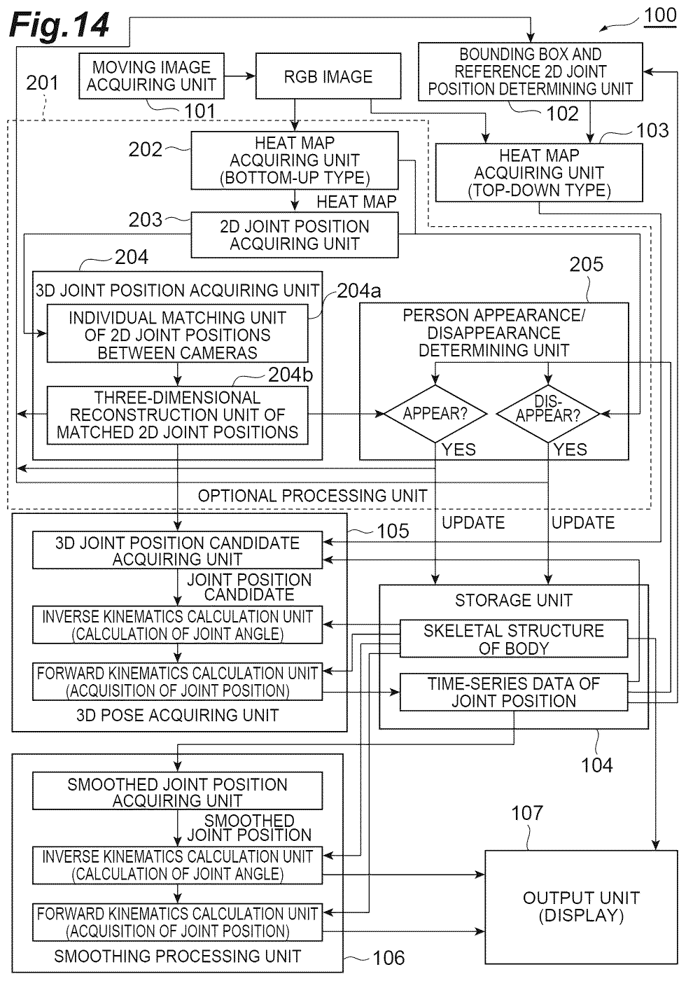

A motion capture system 100 according to the present disclosure will be described below. The motion capture system 100 according to the present disclosure is based on Chapter I and Chapter II. FIG. 14 is a block diagram illustrating a functional configuration of the motion capture system 100 according to the present disclosure. The motion capture system 100 includes a moving image acquiring unit 101, a bounding box and reference 2D joint position determining unit 102, a top-down heat map acquiring unit 103, a storage unit 104, a 3D pose acquiring unit 105, a smoothing processing unit 106, and an output unit 107. The motion capture system 100 further includes an optional processing unit 201. The optional processing unit 201 includes a bottom-up heat map acquiring unit 202, a 2D joint position acquiring unit 203, a 3D joint position acquiring unit 204, and a person appearance/disappearance determining unit 205.

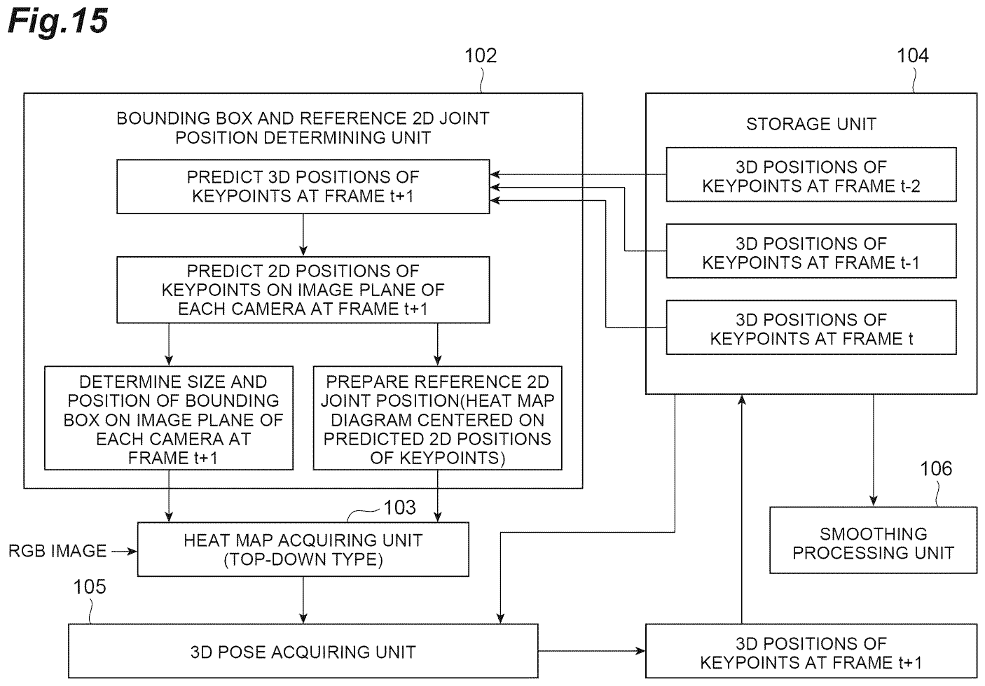

As illustrated in FIG. 14, the bounding box and reference 2D joint position determining unit 102 determines a bounding box and a reference 2D joint position (a reference 2D position), and the top-down heat map acquiring unit 103 acquires a heat map using the bounding box and the reference 2D joint position. These processes will be described with reference to FIG. 15. FIG. 15 is a diagram illustrating detailed processes which are performed by the bounding box and reference 2D joint position determining unit 102 according to an embodiment of the present disclosure. The bounding box and reference 2D joint position determining unit 102 prepares a reference 2D joint position in addition to the bounding box determining process illustrated in FIG. 11, and the 3D pose acquiring unit 105 performs a process of acquiring a 3D pose using the reference 2D joint position.

As illustrated in FIG. 15, the bounding box and reference 2D joint position determining unit 102 acquires 3D positions of each keypoint at the current or previous frames t to t−2 stored in the storage unit 104. Then, the bounding box and reference 2D joint position determining unit 102 predicts a 3D position of each keypoint at the frame t+1. In the present disclosure, the frames t to t−2 are an example, and the present disclosure is not limited to these frames.

Then, the bounding box and reference 2D joint position determining unit 102 predicts a 2D position of each keypoint on an image plane of each camera at the frame t+1. The bounding box and reference 2D joint position determining unit 102 determines a size and position of a bounding box on the image plane of each camera at the frame t+1. The process of determining a size and position of a bounding box is the same as the process described in the article of [C] Determination of bounding box in input image.

In this embodiment, the bounding box and reference 2D joint position determining unit 102 prepares a reference heat map indicating the referenced 2D joint position based on the 3D positions of the keypoints at the previous frames t to t−2 stored in the storage unit 104. This reference heat map is expressed as a heat map centered on the reference 2D joint position. The reference heat map is expressed by multi-dimensional matrix information.

The top-down heat map acquiring unit 103 acquires a heat map based on the bounding box of which the size and position have been determined and the reference heat map indicating the reference 2D joint position. The process of acquiring a heat map is the same as the process described in the article of [D-1] Acquisition of heat map of keypoint of the article of [D] 3D pose acquiring unit. This process is different from the process illustrated in FIG. 11 in that the reference 2D joint position is included in input information.

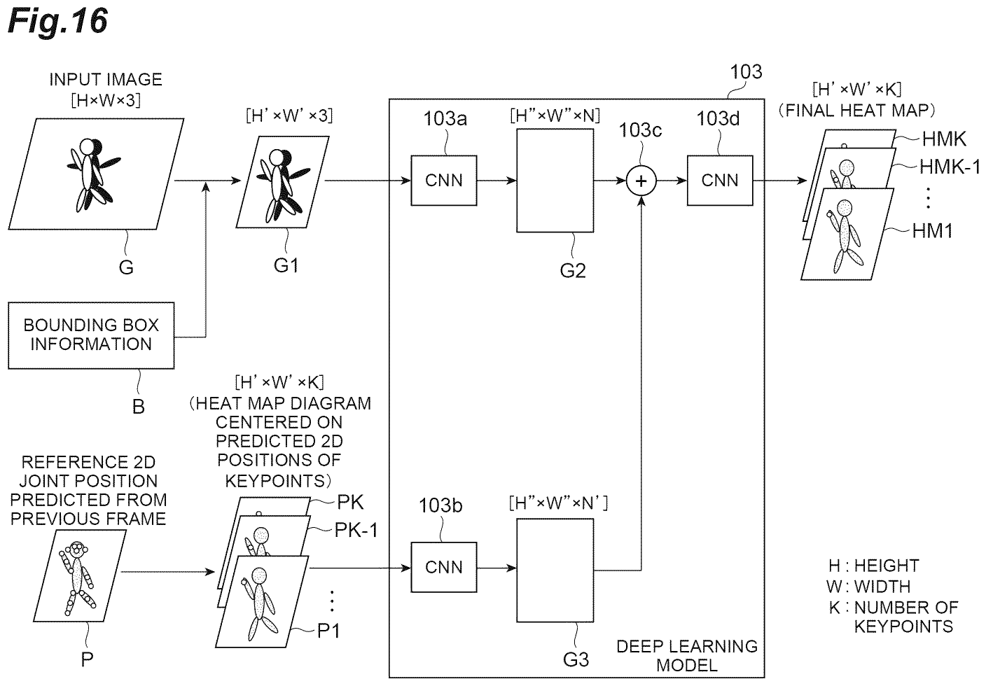

More details will be described below with reference to FIG. 16. FIG. 16 is a diagram illustrating a process of generating a final heat map HM based on the bounding box and the reference 2D pose.

The top-down heat map acquiring unit 103 cuts an image G1 with a size of [H′*W′*3] based on the image G with a size of [H*W*3] acquired by the moving image acquiring unit 101 and the bounding box information B determined by the bounding box and reference 2D joint position determining unit 102. Here, an RGB (three layers) image with a height H and a width W is handled. In FIG. 16, a pose of a nearside person is going to be estimated.

The image G1 is input to a convolutional neural network (CNN) 103a, and a feature map G2 with a changed size of [H″*W″*N] is output therefrom. The feature map G2 is a matrix indicating features of the image G1. The CNN 103a has been trained in advance such that a matrix indicating features of the image G1 is output.

On the other hand, the bounding box and reference 2D joint position determining unit 102 predicts a reference 2D joint position P of each keypoint from the 3D positions at the current or previous frames (such as the frames t and t−1) and prepares a reference heat map of each keypoint. As described above, the reference heat map is matrix information indicating the predicted reference 2D joint position. In FIG. 16, reference heat maps P1 to PK which are reference heat maps with a size of [H′*W′*K] indicating heat maps of keypoints 1 to k are derived. The bounding box and reference 2D joint position determining unit 102 prepares the reference heat maps P1 to PK using the bounding box information B to match the size of the image G1.

The top-down heat map acquiring unit 103 inputs the reference heat maps with a size of [H′*W′*K] (reference heat maps P1 to PK) to a CNN 103b. The CNN 103b outputs a feature map G3 with a changed size of [H″*W″*N]. The feature map G3 is matrix information indicating features of the predicted 2D joint positions. The CNN 103b has been trained in advance such that the features of the 2D joint positions are output in the size of [H″*W″*N].

An adder 103c adds the feature map G2 and the feature map G3 and outputs a feature map with a size of [H″*W″*(N+N′)]. A CNN 103d outputs a heat map with a size of [H′*W′*K] by resizing the feature map with a size of [H″*W″*(N+N′)]. The heat map with a size of [H′*W′*L] corresponds to K heat map layers with a size of [H′*W′]. The CNN 103d has been trained in advance such that a final heat map HM is output based on the feature map G2 for input image information and the feature map G3 for the heat maps based on the 2D joint positions at the current and previous frames.

In this embodiment, learning of the feature map G3 of the reference heat map in addition to the feature map G2 of the input image G1 is performed based on training codes and a trained model of HRNet (Non-Patent Literature 19).

In general, a data set of one image and annotation data describing keypoint positions (joint positions) of a person appearing in the image is known as a published data set (see Non-Patent Literature 15 or the like). An annotation process for a moving image is high in operation cost and is not worth, and thus a still image is used therein. In order to realize this technique, a current pose predicted from the person's motion at the previous frames is prepared as the reference heat map. In this embodiment, the reference heat map is prepared from the annotation data. The technique of generating the reference heat map and a learning method using this technique are not limited to the above description, and various types can be considered.

Since a person's motion does not change excessively fast between close frames, a pose predicted from the past is not often much different from the annotation data. As described above, a deep learning model (including the CNN 103d) is trained as a model for generating a final heat map based on the reference heat map. However, excessive dependency on the reference heat map causes a decrease in estimation performance and a decrease in generalization performance thereof when the reference heat map is much erroneous.

Accordingly, data with the following disturbance may be prepared and learning of the data may be performed.
Noise of a random position is added to the annotation data.
Random rotation about a random part of a body is performed on the annotation data.
An enlargement/reduction process is performed on the annotation data.
A part of the annotation data is deleted.

As a disturbing operation, one or more operations of the aforementioned disturbance may be performed or all of them may be performed.

For the purpose of convenience, it has been described above that the heat map acquiring unit 103 includes the CNNs 103a to 103d and a model is provided for each CNN, but learning is actually performed using a deep learning model having learned a relationship between two inputs (an input image and a reference heat map) and one output (a heat map). The deep learning model is trained using the methods described in the article of [B] Heat map acquiring unit and Non-Patent Literatures 18 to 20.

Through the aforementioned processes, the top-down heat map acquiring unit 103 can output a final heat map HM (with a size of [H′*W′*K]).

The 3D pose acquiring unit 105 is a part corresponding to the joint position acquiring unit in the article of [I] Motion capture system. The 3D pose acquiring unit 105 is a part receiving a heat map acquired by the top-down heat map acquiring unit 103 and acquiring a 3D pose. This acquisition process is the same as described in the articles of [D-1] Acquisition of heat map of keypoint to [D-4] Acquisition of joint position in the article of [D] 3D pose acquiring unit.

The smoothing processing unit 106 is a part corresponding to the smoothing processing unit in the article of [I] Motion capture system.

In one embodiment of the present disclosure, the following configuration may be provided in an optional process. That is, the motion capture system 100 may further include the bottom-up heat map acquiring unit 202, the 2D joint position acquiring unit 203, the 3D joint position acquiring unit 204, and the person appearance/disappearance determining unit 205 for performing the optional process.

The bottom-up heat map acquiring unit 202 is a part acquiring a heat map of each person by estimating poses of multiple persons in an image area and joining the poses for each person. This part is a processing technique of performing person detection and pose estimation in an image, which can be performed fast, and is likely to have lower precision in comparison with a top-down type.

The 2D joint position acquiring unit 203 is a part acquiring a 2D joint position using the heat map acquired by the bottom-up heat map acquiring unit 202.

The 3D joint position acquiring unit 204 includes a matching unit 204a and a three-dimensional reconstruction unit 204b. The matching unit 204a is a part performing a matching process on the 2D joint positions acquired from the cameras for each person. The matching process is a process of collecting 2D joint positions acquired based on RGB images captured by the cameras for each person. The three-dimensional reconstruction unit 204b performs three-dimensional development based on the collected 2D joint positions to construct a 3D joint position for each person. The 3D joint position acquiring unit 204 acquires the 3D joint positions from the 2D joint positions in this way.

The person appearance/disappearance determining unit 205 determines whether a person appears or disappears in an RGB image by comparing the 3D joint position acquired by the 3D joint position acquiring unit 204 and/or the 2D joint position acquired by the 2D joint position acquiring unit 203 with time-series data (a 3D position) in the storage unit 104. The person appearance/disappearance determining unit 205 compares the 3D joint position with the time-series data and determines that a person appears when the 3D joint position is greater. On the other hand, the person appearance/disappearance determining unit 205 compares the 2D joint position with the time-series data and determines that a person disappears when the 2D joint position is less. At the time of determination of disappearance of a person, the person appearance/disappearance determining unit 205 may compare the heat map acquired by the bottom-up heat map acquiring unit 202 with the time-series data.

When the 3D joint position has been erroneously acquired and then the acquired 3D joint position is erroneously lost, the person appearance/disappearance determining unit 205 may determine that a person disappears. In the technique of the present disclosure, preparation robust to occlusion is performed, but the 3D joint position may be actually acquired much erroneously in a situation in which much occlusion occurs. When the 3D joint position is acquired much erroneously, acquisition of a subsequent 3D joint position is likely to fail sequentially, which is not desirable. Accordingly, such deletion of erroneous acquisition is preferably handled as disappearance of a person.

The person appearance/disappearance determining unit 205 may determine disappearance of a person based on departure of a target from a field of view of a camera. When a 3D position of the target is known, at what position in a camera image the target appears currently can be seen, and whether the person departs from the field of view can be determined using that information.

The person appearance/disappearance determining unit 205 updates the time-series data and the skeletal structure of a body stored in the storage unit 104 based on the determination result. The person appearance/disappearance determining unit 205 adds the new 3D joint position along with time information thereof to the time-series data of an unchanged person. When a person appears newly, a 3D joint position along with time information thereof is added as time-series data of the new person. When a person disappears, the 3D joint position thereof is not added to the time-series data of the corresponding person. When a new person is added, a structure calculating unit (not illustrated) calculates a skeletal structure of a body of the person again as described in Chapter I and stores the calculated skeletal structure as a skeletal structure of a body of the new person in the storage unit 104.

The person appearance/disappearance determining unit 205 can update the time-series data in consideration of appearance/disappearance of a person and always use new data. Accordingly, it is possible to enhance prediction precision of a 3D pose.

When this optional process is used, the 3D pose acquiring unit 105 acquires joint position candidates using the 3D joint position calculated by the three-dimensional reconstruction unit 204b of the 3D joint position acquiring unit 204 in addition to the heat map acquired by the top-down heat map acquiring unit 103. When the 3D pose acquiring unit 105 acquires the 3D pose and an error between the 3D position in the time-series data and the acquired 3D joint position is large, only the 3D joint position calculated by the three-dimensional reconstruction unit 204b may be used, or an average value or a weighted average value with the time-series data stored in the storage unit 104 may be used.

The time-series data in the storage unit 104 is based on the premise that a person moves at a constant acceleration and thus does not necessarily indicate an accurate 3D joint position. On the other hand, the heat map or the 2D joint position acquired by the bottom-up heat map acquiring unit 202 is acquired by processing an image in a time series and thus accuracy thereof is relatively high. However, since a skeletal structure of each individual body is not considered, the skeletal structure may be slightly distorted. The 3D pose acquiring unit 105 can acquire a 3D pose with high accuracy using that knowledge.

Operations and advantages of the motion capture system 100 which is a 3D position acquisition device according to the present disclosure will be described below. The motion capture system 100 according to the present disclosure performs a 3D position acquisition method in a device acquiring a 3D position of a target through motion capture using a plurality of cameras.

A target of which a 3D position is acquired includes a plurality of keypoints on a body including a plurality of joints, and the 3D position of the target is identified by positions of the plurality of keypoints. The bounding box and reference 2D joint position determining unit 102 determines a bounding box surrounding the target in a camera image at a target frame at which prediction is performed after one frame (after one time) using the 3D positions of the keypoints of the target at one or more frames (corresponding to one time) captured by the plurality of cameras and acquires a reference 2D positions of the keypoints projected onto a predetermined plane from the 3D positions of the keypoints of the target. The 3D pose acquiring unit 105 acquires the 3D positions of the keypoints of the target at the target frame by three-dimensionally reconstructing image information in the bounding box and the reference 2D positions using information of the plurality of cameras.

With this configuration, it is possible to acquire a 3D position of a desired target even in a situation in which a plurality of targets hug or the like and come into close contact or in a situation in which much occlusion occurs by taking into consideration of the reference 2D positions of the keypoints of the target at a current frame t or a previous frame t−1 and the bounding box information. That is, it is possible to acquire 3D positions of keypoints of a target with high precision.

In the present disclosure, the at least one frame is a frame t and/or one or more frames t−1 and t−2 previous to the frame t. The bounding box and reference 2D joint position determining unit 102 predicts and acquires the reference 2D positions of each keypoint at the frames t to t−2.

In the present disclosure, the heat map acquiring unit 103 acquires a first feature map (the feature map G2) of an area designated by the bounding box from an image G1 of the area at the target frame, acquires spatial distribution information indicating 2D positions of the keypoints of the target from the reference 2D positions, and acquires a second feature map (the feature map G3) based on the spatial distribution information. The heat map acquiring unit 103 acquires a final heat map HM based on a combined feature map of the first feature map and the second feature map, and then the 3D pose acquiring unit 105 acquires 3D positions of the keypoints of the target.

The first feature map and the second feature map are output in a common predetermined size from a deep learning model (for example, a CNN). For example, an image G1 with a size of [H′*W′*3] cut from an input image G1 using the bounding box information is input to the CNN 103a, and an image G2 with a size of [H″*W″*N] is output as the first feature map. Similarly, regarding a reference 2D joint position P, a heat map with a size of [H′*W′*K] is input to the CNN 103b, and an image G3 with a size of [H″*W″*N′] is output as the second feature map.

When the 3D positions of the keypoints are acquired, the heat map acquiring unit 103 outputs spatial distribution information (the heat map HM) indicating a likelihood of certainty of each keypoint from the CNN 103d of the deep learning model, and the 3D pose acquiring unit 105 acquires a 3D position of the keypoint based on the spatial distribution information. The spatial distribution information is expressed by matrix information with a size of [H″*W″*K].

In the present disclosure, the 3D pose acquiring unit 105 may acquire the 3D positions of the keypoints of the target at a target frame using reconstructed 3D positions of the keypoints of the target acquired by three-dimensionally reconstructing the 2D positions of the keypoints of the target in a plurality of images captured by the plurality of cameras in addition to reference heat maps (the reference heat maps P1 to PK) based on the image G2 and the reference 2D joint position.

With this configuration, it is possible to avoid processing based on information which has been erroneously estimated and to determine whether such estimation is not performed. That is, the 3D pose acquiring unit 105 acquires a 3D pose (a 3D position) of a target from the heat maps acquired by the heat map acquiring unit 103 and the time-series data of the joint positions stored in the storage unit 104, but the time-series data may include unevenness or errors. Accordingly, it is possible to accurately predict the 3D position of the target by determining whether the time-series data includes an error based on the 3D positions of the target which have been individually predicted or using an average value or a weighted average value of the 3D position in the time-series data and the 3D position acquired through three-dimensional reconstruction.

In the present disclosure, the motion capture system 100 stores history data of the 3D positions of the keypoints of the target in the storage unit 104. Then, the person appearance/disappearance determining unit 205 determines a state (appearance or disappearance) of the target by comparing the reconstructed 3D positions of the keypoints of the target or the pre-reconstruction 2D positions of the target with the 3D positions of the keypoints of the target stored in the storage unit 104 and updates the history data of the 3D positions of the keypoints of the target in the storage unit 104 based on the determination result.

Accordingly, it is possible to determine appearance or disappearance of a target, to update the history data therewith, and to always store new information in the storage unit 104.

The block diagrams used to describe the aforementioned embodiments show blocks of functional units. These functional blocks (constituent units) are realized by an arbitrary combination of at least one of hardware and software. The realization method of each functional block is not particularly limited. That is, each functional block may be realized by a single device which is physically or logically coupled, or may be realized by two or more devices which are physically or logically separated and which are directly or indirectly connected (for example, in a wired or wireless manner). Each functional block may be realized by combining software with the single device or the two or more devices.

The functions include determining, deciding, judging, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (a constituent unit) for transmitting is referred to as a transmitting unit or a transmitter. As described above, the realization method of each function is not particularly limited.

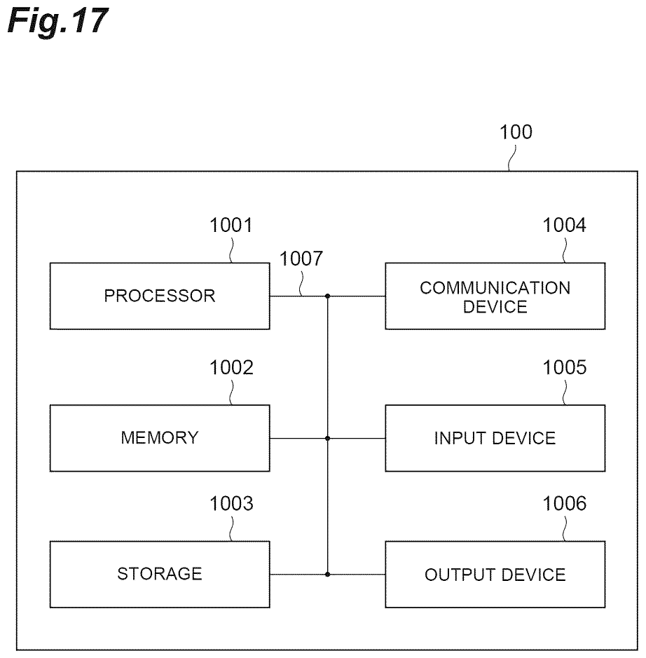

For example, the motion capture system 100 according to one embodiment of the present disclosure may serve as a computer that performs the processing steps of the method of acquiring 3D positions of keypoints according to the present disclosure. FIG. 17 is a diagram illustrating an example of a hardware configuration of the motion capture system 100 according to one embodiment of the present disclosure. The motion capture system 100 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware configuration of the motion capture system 100 may be configured to include one or more devices illustrated in the drawing or may be configured to exclude some devices thereof.

The functions of the motion capture system 100 can be realized by reading predetermined software (program) to hardware such as the processor 1001 and the memory 1002 and causing the processor 1001 to execute arithmetic operations and to control communication using the communication device 1004 or to control at least one of reading and writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the bounding box and reference 2D joint position determining unit 102, the heat map acquiring unit 103, and the like may be realized by the processor 1001.

The processor 1001 reads a program (a program code), a software module, data, or the like from at least one of the storage 1003 and the communication device 1004 to the memory 1002 and performs various processes in accordance therewith. As the program, a program that causes a computer to perform at least some of the operations described in the above-mentioned embodiment is used. For example, the bounding box and reference 2D joint position determining unit 102 of the motion capture system 100 may be realized by a control program which is stored in the memory 1002 and which operates in the processor 1001, and the other functional blocks may be realized in the same way. The various processes described above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (a program code), a software module, and the like that can be executed to perform the 3D position acquisition method according to an embodiment of the present disclosure.

The storage 1003 is a computer-readable storage medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media may be, for example, a database, a server, or another appropriate medium including at least one of the memory 1002 and the storage 1003.

The communication device 1004 is hardware (a transmitting and receiving device) that performs communication between computers via at least one of a wired network and a wireless network and is also referred to as, for example, a network device, a network controller, a network card, or a communication module. The communication device 1004 may include a radio-frequency switch, a duplexer, a filter, and a frequency synthesizer to realize at least one of frequency division duplex (FDD) and time division duplex (TDD).

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The motion capture system 100 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted using at least one piece of the hardware.

Notifying of information is not limited to the aspects/embodiments described in the present disclosure, and may be performed using another method. For example, notifying of information may be performed using physical layer signaling (for example, downlink control information (DCI), uplink control information (UCI)), upper layer signaling (for example, radio resource control (RRC) signaling, medium access control (MAC) signaling, notification information (master information block (MIB), or system information block (SIB)), other signaling, or a combination thereof. RRC signaling may be referred to as an RRC message and may be, for example, an RRC connection setup message or an RRC connection reconfiguration message.

The order of processing steps, the sequences, the flowcharts, and the like of the aspects/embodiments described above in the present disclosure may be changed unless conflictions arise. For example, in the methods described in the present disclosure, various steps are described as elements in the exemplary order, and the methods are not limited to the described specific order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison between numerical values (for example, comparison with a predetermined value).

The aspects/embodiments described in the present disclosure may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

While the present disclosure has been described above in detail, it will be apparent to those skilled in the art that the present disclosure is not limited to the embodiments described in the present disclosure. The present disclosure can be altered and modified in various forms without departing from the gist and scope of the present disclosure defined by description in the appended claims. Accordingly, the description in the present disclosure is for exemplary explanation and does not have any restrictive meaning for the present disclosure.

Regardless of whether it is called software, firmware, middleware, microcode, hardware description language, or another name, software can be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, commands, information, and the like may be transmitted and received via a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), the at least one of wired technology and wireless technology is included in definition of the transmission medium.

Information, signals, and the like described in the present disclosure may be expressed using one of various different techniques. For example, data, instructions, commands, information, signals, bits, symbols, and chips which can be mentioned in the overall description may be expressed by a voltage, a current, electromagnetic waves, a magnetic field or magnetic particles, a photo field or photons, or an arbitrary combination thereof.

Terms described in the present disclosure and terms required for understanding the present disclosure may be substituted with terms having the same or similar meanings. For example, at least one of a channel and a symbol may be a signal (signaling). A signal may be a message. A component carrier (CC) may be referred to as a carrier frequency, a cell, a frequency carrier, or the like.

Information, parameters, and the like described above in the present disclosure may be expressed using absolute values, may be expressed using values relative to predetermined values, or may be expressed using other corresponding information. For example, radio resources may be indicated by indices.

The term “determining” or “determination” used in the present disclosure may include various types of operations. The term “determining” or “determination” may include cases in which judging, calculating, computing, processing, deriving, investigating, looking up, search, or inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.” “Determining” may be replaced with “assuming,” “expecting,” “considering,” or the like.

The terms “connected” and “coupled” or all modifications thereof refer to all direct or indirect connecting or coupling between two or more elements, and can include a case in which one or more intermediate elements are present between the two elements “connected” or “coupled” to each other. Coupling or connecting between elements may be physical, logical, or a combination thereof. For example, “connecting” may be replaced with “accessing.” In the present disclosure, two elements can be considered to be “connected” or “coupled” to each other using at least one of one or more electrical wires, cables, and printed circuits and using electromagnetic energy or the like having wavelengths of a radio frequency area, a microwave area, and a light (both visible and invisible light) area in some non-limiting and non-inclusive examples.

The expression “based on ˜” used in the present disclosure does not mean “based on only ˜” unless otherwise described. In other words, the expression “based on ˜” means both “based on only ˜” and “based on at least ˜.”

No reference to elements named with “first,” “second,” or the like used in the present disclosure generally limit amounts or order of the elements. These naming can be used in the present disclosure as a convenient method for distinguishing two or more elements. Accordingly, reference to first and second elements does not mean that only two elements are employed or that a first element precedes a second element in any form.

When the terms “include” and “including” and modifications thereof are used in the present disclosure, the terms are intended to have a comprehensive meaning similarly to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, the expression “A and B are different” may mean that “A and B are different from each other.” The expression may mean that “A and B are different from C.” Expressions such as “separated” and “coupled” may be construed in the same way as “different.”

### INDUSTRIAL APPLICABILITY

The aforementioned motion capture system is applicable to various fields such as sports (such as kinematic analysis, coaching, tactical proposal, automatic scoring of sport competition, or detailed log of training), smart life (such as general healthy life, elderly person watching, or finding of suspicious behavior), entertainments (such as live performance, CG preparation, or virtual reality games or augmented games), nursing, and medical care.

### REFERENCE SIGNS LIST

101 . . . . Moving image acquiring unit, 102 . . . . Joint position determining unit, 103 . . . . Heat map acquiring unit, 103c . . . . Adder, 104 . . . . Storage unit, 105 . . . 3D pose acquiring unit, 106 . . . . Smoothing processing unit, 107 . . . . Output unit, 201 . . . . Optional processing unit, 202 . . . . Heat map acquiring unit, 203 . . . 2D joint position acquiring unit, 204 . . . 3D joint position acquiring unit, 204a . . . . Matching unit, 204b . . . . Three-dimensional reconstruction unit, 205 . . . . Person appearance and disappearance determining unit

1. A 3D position acquisition method that is performed by a device acquiring a 3D position of a target through motion capture using a plurality of cameras,
wherein the target includes a plurality of keypoints of a body including a plurality of joints and the 3D position of the target is identified by positions of the plurality of keypoints, and
wherein the 3D position acquisition method comprises:
determining a bounding box surrounding the target in a camera image at a target time to be predicted subsequent to at least one time at which imaging is performed by the plurality of cameras using the 3D positions of the keypoints of the target at the at least one time and acquiring reference 2D positions of the keypoints projected from the 3D positions of the keypoints of the target onto a predetermined plane; and
acquiring the 3D positions of the keypoints of the target after the at least one time by performing three-dimensional reconstruction using image information in the bounding box, the reference 2D positions, and information of the plurality of cameras.

2. The 3D position acquisition method according to claim 1, wherein the at least one time is time t and/or one or more times prior to time t, and
wherein the reference 2D positions of the keypoints of the target are acquired from the 3D positions of the keypoints of the target at the at least one time.

3. The 3D position acquisition method according to claim 1, wherein a keypoint map of the target for each of the plurality of cameras is acquired from keypoint maps based on an image of an area designated by the bounding box at the target time and spatial distribution information indicating 2D positions of the keypoints of the target and the 3D positions of the keypoints of the target are acquired through three-dimensional reconstruction from the keypoint maps of the plurality of cameras.

4. The 3D position acquisition method according to claim 3, wherein spatial distribution information indicating likelihoods of certainty of 2D positions for the keypoints is output from a deep learning model and the 3D positions of the keypoints are acquired based on the spatial distribution information.

5. The 3D position acquisition method according to claim 1, wherein the 3D positions of the keypoints of the target at the target time are acquired using reconstructed 3D positions of the keypoints of the target acquired through three-dimensional reconstruction of the 2D positions of the keypoints of the target in a plurality of images captured by the plurality of cameras in addition to the 3D positions of the target at the at least one time.

6. The 3D position acquisition method according to claim 5, wherein history data of the 3D positions of the keypoints of the target is stored in a storage unit,
wherein a state of the target is determined by comparing the reconstructed 3D positions of the keypoints of the target or the pre-constructed 2D positions of the target with the history data of the keypoints of the target stored in the storage unit, and
wherein the history data of the 3D positions of the keypoints of the target in the storage unit is updated based on the result of determination.

7. A 3D position acquisition device acquiring 3D positions of keypoints on a body including a plurality of joints of a target through motion capture using a plurality of cameras, the 3D position acquisition device comprising:
a determination unit configured to determine a bounding box surrounding the target in a camera image at a target time to be predicted subsequent to at least one time at which imaging is performed by the plurality of cameras using the 3D positions of the keypoints of the target at the at least one time and to acquire reference 2D positions of the keypoints projected from the 3D positions of the keypoints of the target onto a predetermined plane; and
an acquisition unit configured to acquire the 3D positions of the keypoints of the target at the target time by performing three-dimensional reconstruction using image information in the bounding box, the reference 2D positions, and information of the plurality of cameras.
